(19) United States
(12) Patent Application Publication
(10) Pub. No.: US 2026/0352053 A1
(43) Pub. Date: Nov. 5, 2026

(54) STATOR AND ROTATING ELECTRICAL MACHINE

(71) Applicant: DENSO CORPORATION, Kariya-city (JP)

(72) Inventors: Ryo MITANI, Kariya-city (JP); Naoto NATSUME, Kariya-city (JP); Masayuki ECHIZEN, Kariya-city (JP)

(73) Assignee: DENSO CORPORATION, Kariya-city (JP)

(21) Appl. No.: 19/727,579

(22) Filed: Jul. 1, 2026

Related U.S. Application Data
(63) Continuation of application No. PCT/JP2024/041864, filed on Nov. 26, 2024.

(30) Foreign Application Priority Data
Feb. 13, 2024 (JP) 2024-019751
Feb. 13, 2024 (JP) 2024-019752
Nov. 7, 2024 (JP) 2024-195492

(51) Int. Cl. H02K 3/34; H02K 1/14

(52) U.S. Cl. CPC H02K 3/345; H02K 1/146; H02K 2203/12

(57) ABSTRACT

A stator including: a stator core having teeth extending radially; a plurality of insulators attached to the teeth; and a plurality of the wire-wound portions wound around the teeth through the insulators. Each of the insulators includes a pair of insulating portions extending in an axial direction of the stator core and arranged on both sides of a corresponding one of the teeth in a tangential direction of the stator core. A gas layer and the insulating portions are arranged between the tooth and the wire-wound portion in the tangential direction of the stator core.

### CROSS REFERENCE TO RELATED DOCUMENT

The present application claims the benefit of priority of Japanese Patent Application No. 2024-019751 filed on Feb. 13, 2024, Japanese Patent Application No. 2024-019752 filed on Feb. 13, 2024, and Japanese Patent Application No. 2024-195492 filed on Nov. 7, 2024, the disclosures of which are incorporated in their entirety herein by reference.

### TECHNICAL FIELD

This disclosure relates generally to a stator and a rotating electrical machine.

BACKGROUND ART

A stator is known that includes a stator core having a plurality of teeth extending radially, insulators mounted on the stator core, and a plurality of wire-wound portions (i.e., windings) formed by wires wound around the teeth through the insulators. Further, among such stators, some are configured such that insulators are mounted on axial end faces of the teeth and insulating papers are arranged on side surfaces of the teeth (see, for example, Japanese Unexamined Patent Application Publication No. 2018-198515).

### SUMMARY OF THE INVENTION

As a result of detailed studies conducted by the inventor, the following problem has been found. In the stator configured as described above, when a high voltage is applied to the wire-wound portions, dielectric breakdown may occur in the insulating papers. Therefore, as a countermeasure against dielectric breakdown, it is conceivable to use insulators thicker than the insulating papers. However, in this case, the space factor of the wire-wound portions decreases.

It is an object of this disclosure to provide a stator and a rotating electrical machine capable of ensuring insulation properties for windings without decreasing the space factor of the windings.

According to the first aspect of this disclosure, there is provided a stator which comprises: (a) a stator core having teeth extending in a radial direction of the stator core; (b) a plurality of insulators that are installed on the teeth; (c) a plurality of wire-wound portions that are formed by wires wound around the teeth through the insulators; (d) a pair of insulating portions that extend in an axial direction of the stator core and are disposed on opposite sides of each of the teeth in a tangential direction of the stator core; and (e) gas layers, each of which is disposed together with a respective one of the insulators between a corresponding one of the teeth and a corresponding one of the wire-wound portions in the tangential direction.

According to the second aspect of this disclosure, there is provided a stator which comprises: (a) a stator core having teeth extending in a radial direction of the stator core; (b) a plurality of insulators that are installed on the teeth; and (c) a plurality of wire-wound portions that are formed by wires wound around the teeth through the insulators. Each of the insulators includes a first insulator and a second insulator which are discrete from each other at a dividing portion. The first insulator and the second insulator have an overlapping structure in which the first insulator includes a first overlapping portion. The second insulator includes a second overlapping portion overlapping the first overlapping portion. The dividing portion passes between the first overlapping portion and the second overlapping portion.

According to the third aspect of this disclosure, there is provided a stator which comprises: (a) a stator core having a plurality of teeth extending in a radial direction of the stator core; (b) a plurality of insulators mounted on the teeth; and (c) a plurality of wire-wound portions wound around the teeth through the insulators. Each of the insulators includes a first insulator and a second insulator which are discrete from each other at a dividing portion. The first insulator and the second insulator are in close contact with each other at the dividing portion.

According to the fourth aspect of this disclosure, there is provided a stator which comprises: (a) a stator core having a plurality of teeth extending in a radial direction of the stator core; (b) a plurality of insulators mounted on the teeth; and (c) a plurality of wire-wound portions wound around the teeth through the insulators. Each of the insulators includes a pair of insulating portions extending in an axial direction of the stator core and disposed on opposite sides of a corresponding one of the teeth in a tangential direction of the stator core. A gas layer is provided between a corresponding one of the teeth and one of the insulating portions in the tangential direction of the stator core.

According to the fifth aspect of this disclosure, there is provided a stator which comprises: (a) a stator core having a plurality of teeth extending in a radial direction of the stator core; (b) a plurality of insulators mounted on the teeth; and (c) a plurality of wire-wound portions wound around the teeth through the insulators. Each of the insulators includes a pair of first insulating portions extending in an axial direction of the stator core and disposed on opposite sides of a corresponding one of the teeth in a tangential direction of the stator core. First gas layers are arranged between a corresponding one of the wire-wound portions and the first insulating portions of a corresponding one of the insulators in the tangential direction of the stator core.

According to the sixth aspect of this disclosure, there is provided a rotating electrical machine comprising: the stator according to any one of the above-described first to fifth aspects; and a rotor rotatably disposed inside the stator.

### BRIEF DESCRIPTION OF THE DRAWINGS

FIG. 1 is a plan view of a stator according to the first embodiment.

FIG. 2 is a perspective view of stator structural members according to the first embodiment.

FIG. 3 is a perspective view of a core member and an insulator according to the first embodiment.

FIG. 4 is an exploded perspective view of the core member and the insulator shown in FIG. 3 according to the first embodiment.

FIG. 5 is an enlarged longitudinal cross-sectional view of essential parts of stator structural members according to the first embodiment.

FIG. 6 is an enlarged longitudinal cross-sectional view of essential parts showing a modified example of stator structural members according to the first embodiment.

FIG. 7 is an enlarged longitudinal cross-sectional view of essential parts of stator structural members according to a second embodiment.

FIG. 8 is an enlarged longitudinal cross-sectional view of essential parts showing a modified example of stator structural members according to the second embodiment.

FIG. 9 is an exploded perspective view of core members and an insulator according to the third embodiment.

FIG. 10 is an exploded perspective view of core members and an insulator according to the fourth embodiment.

FIG. 11 is an enlarged longitudinal cross-sectional view of essential parts of stator structural members according to the fifth embodiment.

FIG. 12 is an exploded perspective view of core members and an insulator according to the sixth embodiment.

FIG. 13 is an enlarged longitudinal cross-sectional view of essential parts of stator structural members according to the sixth embodiment.

FIG. 14 is an enlarged longitudinal cross-sectional view of essential parts showing a first modified example of stator structural members according to the sixth embodiment.

FIG. 15 is an enlarged longitudinal cross-sectional view of essential parts showing a second modified example of stator structural members according to the sixth embodiment.

FIG. 16 is an enlarged longitudinal cross-sectional view of essential parts of stator structural members according to the seventh embodiment.

FIG. 17 is an enlarged longitudinal cross-sectional view of essential parts showing a first modified example of stator structural members according to the seventh embodiment.

FIG. 18 is an enlarged longitudinal cross-sectional view of essential parts showing a second modified example of stator structural members according to the seventh embodiment.

FIG. 19 is an exploded perspective view of core members and an insulator according to the eighth embodiment.

FIG. 20 is an enlarged longitudinal cross-sectional view of essential parts of stator structural members according to the ninth embodiment.

FIG. 21 is a cross-sectional view taken along line A-A of FIG. 20.

FIG. 22 is an enlarged longitudinal cross-sectional view of essential parts showing a first modified example of stator structural members according to the ninth embodiment.

FIG. 23 is a cross-sectional view taken along line B-B of FIG. 22.

FIG. 24 is an enlarged longitudinal cross-sectional view of essential parts showing a second modified example of stator structural members according to the ninth embodiment.

FIG. 25 is an enlarged longitudinal cross-sectional view of essential parts of stator structural members according to the tenth embodiment.

FIG. 26 is an enlarged longitudinal cross-sectional view of essential parts showing a first modified example of stator structural members according to the tenth embodiment.

FIG. 27 is an enlarged longitudinal cross-sectional view of essential parts showing a second modified example of stator structural members according to the tenth embodiment.

FIG. 28 is an exploded perspective view of core members and an insulator according to the eleventh embodiment.

FIG. 29 is an enlarged longitudinal cross-sectional view of essential parts of stator structural members according to the eleventh embodiment.

FIG. 30 is an enlarged longitudinal cross-sectional view of essential parts showing a first modified example of stator structural members according to the eleventh embodiment.

FIG. 31 is an enlarged longitudinal cross-sectional view of essential parts showing a second modified example of stator structural members according to the eleventh embodiment.

FIG. 32 is an enlarged longitudinal cross-sectional view of essential parts of stator structural members according to the twelfth embodiment.

FIG. 33 is an enlarged longitudinal cross-sectional view of essential parts showing a first modified example of stator structural members according to the twelfth embodiment.

FIG. 34 is an enlarged longitudinal cross-sectional view of essential parts showing a second modified example of stator structural members according to the twelfth embodiment.

FIG. 35 is an enlarged longitudinal cross-sectional view of essential parts of stator structural members according to the thirteenth embodiment.

FIG. 36 is an enlarged longitudinal cross-sectional view of essential parts of stator structural members according to the fourteenth embodiment.

FIG. 37 is an enlarged longitudinal cross-sectional view of essential parts showing a first modified example of stator structural members according to the fourteenth embodiment.

FIG. 38 is an enlarged longitudinal cross-sectional view of essential parts showing a second modified example of stator structural members according to the fourteenth embodiment.

FIG. 39 is an enlarged longitudinal cross-sectional view of essential parts of stator structural members according to the fifteenth embodiment.

FIG. 40 is an enlarged longitudinal cross-sectional view of essential parts showing a first modified example of stator structural members according to the fifteenth embodiment.

FIG. 41 is an enlarged longitudinal cross-sectional view of essential parts showing a second modified example of stator structural members according to the fifteenth embodiment.

FIG. 42 is a plan view of a stator according to the sixteenth embodiment.

FIG. 43 is a perspective view of stator structural members according to the sixteenth embodiment.

FIG. 44 is a perspective view of core members and an insulator according to the sixteenth embodiment.

FIG. 45 is an exploded perspective view of core members and an insulator according to the sixteenth embodiment.

FIG. 46 is a longitudinal cross-sectional view of stator structural members according to the sixteenth embodiment.

FIG. 47 is a longitudinal cross-sectional view showing a first modified example of stator structural members according to the sixteenth embodiment.

FIG. 48 is a longitudinal cross-sectional view showing a second modified example of stator structural members according to the sixteenth embodiment.

FIG. 49 is a perspective view of stator structural members according to the seventeenth embodiment.

FIG. 50 is a perspective view of core members and an insulator according to the seventeenth embodiment.

FIG. 51 is an exploded perspective view of core members and an insulator according to the seventeenth embodiment.

FIG. 52 is a plan view of a core member according to the seventeenth embodiment.

FIG. 53 is a longitudinal cross-sectional view of stator structural members according to the seventeenth embodiment.

FIG. 54 is a longitudinal cross-sectional view showing a modified example of stator structural members according to the seventeenth embodiment.

FIG. 55 is a perspective view of stator structural members according to the eighteenth embodiment.

FIG. 56 is a perspective view of core members and an insulator according to the eighteenth embodiment.

FIG. 57 is an exploded perspective view of core members and an insulator according to the eighteenth embodiment.

FIG. 58 is a longitudinal cross-sectional view showing a first modified example of stator structural members according to the eighteenth embodiment.

FIG. 59 is a longitudinal cross-sectional view showing a second modified example of stator structural members according to the eighteenth embodiment.

FIG. 60 is a longitudinal cross-sectional view showing a third modified example of the stator structural member according to the eighteenth embodiment.

FIG. 61 is a perspective view of stator structural members according to the nineteenth embodiment.

FIG. 62 is a perspective view of core members and an insulator according to the nineteenth embodiment.

FIG. 63 is an exploded perspective view of core members and an insulator according to the nineteenth embodiment.

FIG. 64 is a longitudinal cross-sectional view of stator structural members according to the nineteenth embodiment.

FIG. 65 is a perspective view showing a modified example of stator structural members according to the nineteenth embodiment.

FIG. 66 is a perspective view showing a modified example of core members and an insulator according to the nineteenth embodiment.

FIG. 67 is an exploded perspective view showing a modified example of core members and an insulator according to the nineteenth embodiment.

FIG. 68 is a longitudinal cross-sectional view of stator structural members according to the twentieth embodiment.

FIG. 69 is a longitudinal cross-sectional view showing a modified example of stator structural members according to the twentieth embodiment.

### MODES FOR CARRYING OUT THE INVENTION

### First Embodiment

The first embodiment in this disclosure will be described below.

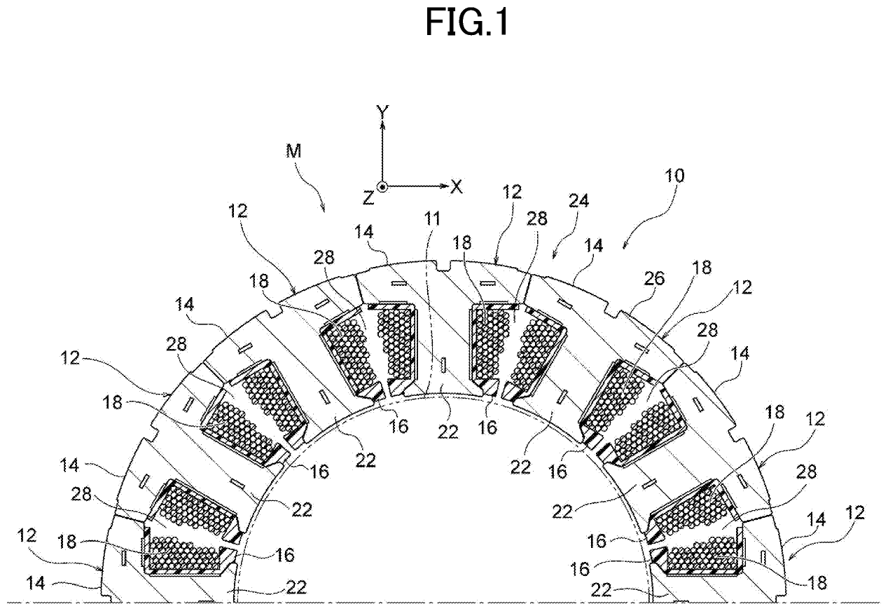

As illustrated in FIG. 1, the rotating electrical machine M includes the stator 10 and the rotor 11. The stator 10 is formed in an annular shape. The rotor 11 is rotatably disposed inside the stator 10. The stator 10 and the rotor 11 constitute an inner-rotor brushless motor.

The stator 10 includes a plurality of stator core members 12. The stator 10 is configured by combining the stator core members 12 in an annular shape. FIG. 1 illustrates a configuration of a half of the stator 10. The stator 10 is used in a brushless motor. Examples of the brushless motor include a fan motor, a pump driving motor, and a compressor motor.

Throughout the drawings, the X-direction indicates a tangential direction of the stator 10, the Y-direction indicates a radial direction of the stator 10, and the Z-direction indicates an axial direction of the stator 10. In the following discussion, a circumferential direction of the stator 10 refers to a direction around a central axis of the stator 10. A tangential direction, a radial direction, an axial direction, and a circumferential direction of the stator core 24, which will be described later, are the same as the tangential direction, the radial direction, the axial direction, and the circumferential direction of the stator 10, respectively.

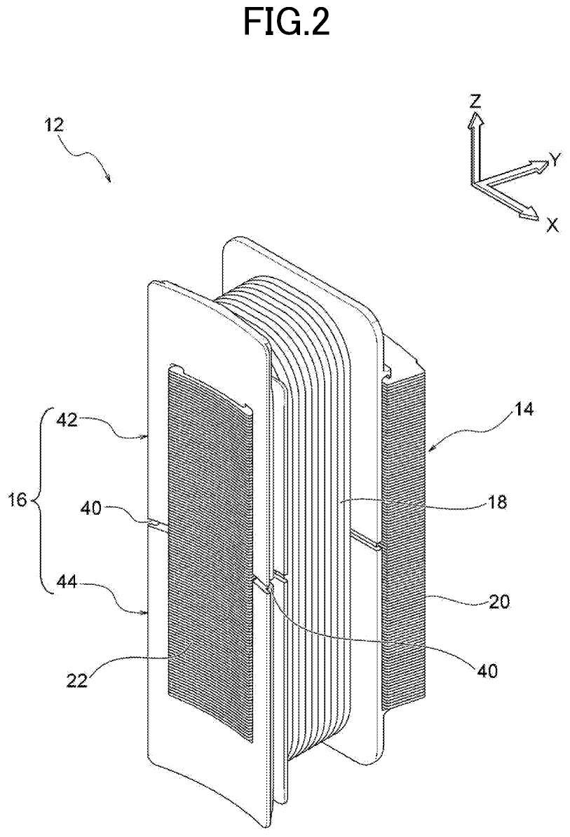

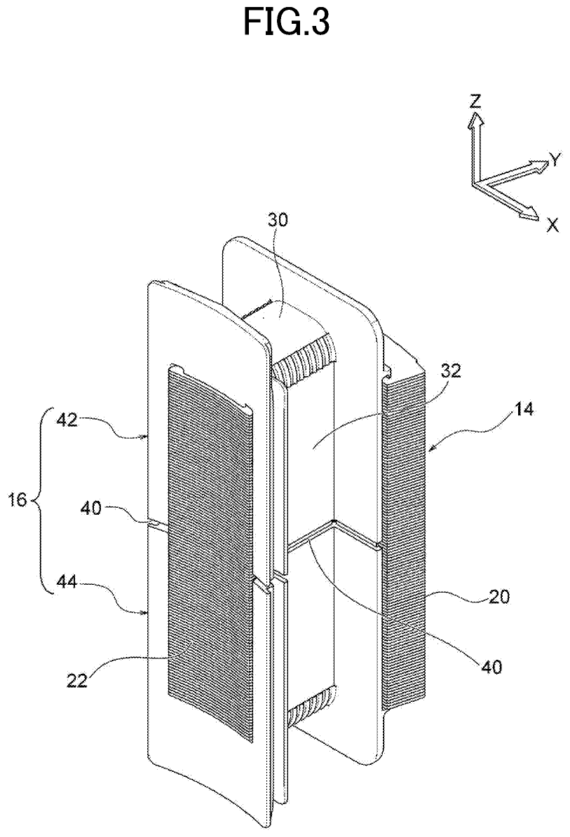

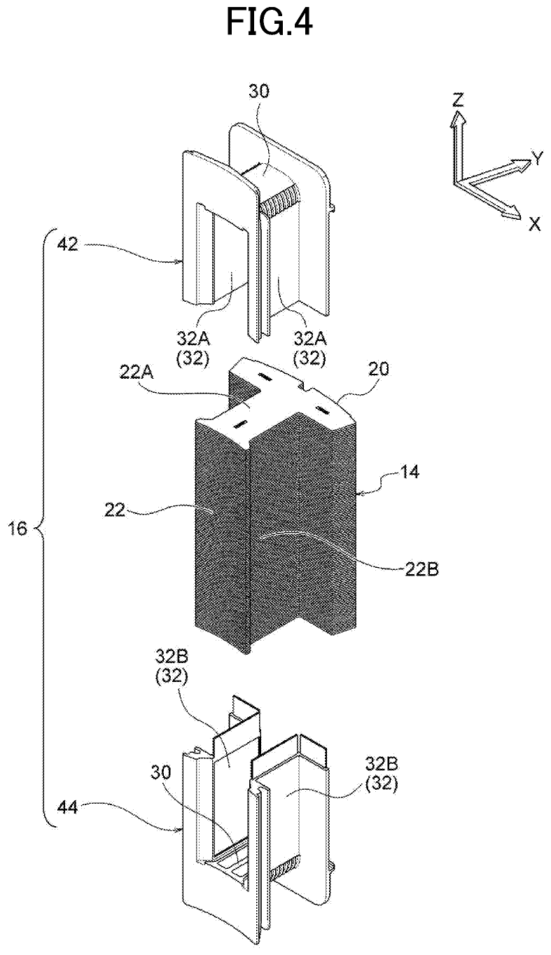

As illustrated in FIG. 2 to FIG. 4, each of the stator core members 12 includes the core member 14, the insulator 16, and the wire-wound portion (i.e., a conductor winding) 18. The core member 14 is formed in a T-shape in a plan view, and has the core back 20 and the tooth 22. The core back 20 extends in the circumferential direction of the stator core 24. The tooth 22 extends from a central portion of the core back 20 inward in the Y-direction. A distal end portion of the tooth 22 is the free end, and a proximal end portion of the tooth 22 is connected to the core back 20.

The stator core 24 (see FIG. 1) is configured by arranging the core members 14 in an annular shape. After the stator core 24 is configured, the core backs 20 form the annular portion 26 (see FIG. 1) that is an outer peripheral portion of the stator core 24. The teeth 22 extend radially around the central portion of the stator core 24. An interval between a respective adjacent two of the teeth 22 is formed as the slot 28.

In each of the stator core members 12, the insulator 16 is attached to the core member 14. Specifically, the insulator 16 is attached to the tooth 22 so as to surround the tooth 22 around the Y-direction. The insulator 16 is made of resin. Examples of the resin forming the insulator 16 include the polyimide, the polyamide, the polyphenylene sulfide (PPS), the polybutylene terephthalate (PBT), and the like. The resin forming the insulator 16 may be any resin. For the sake of simplicity, the following discussion refers to only one of the stator core members 12 unless otherwise specified.

The wire-wound portion 18 is formed by wire wound around the tooth 22 through the insulator 16. The wire-wound portion 18 is made of a winding wound around the tooth 22 in the Y-direction.

The insulator 16 has a pair of first insulating portions 30 and a pair of second insulating portions 32. The first insulating portions 30 respectively extend in the X-direction. The first insulating portions 30 are arranged on ends of the tooth 22 opposite to each other in the Z-direction and respectively cover the end faces 22A of the tooth 22 opposite to each other in the Z-direction. The second insulating portions 32 respectively extend in the Z-direction. The second insulating portions 32 are arranged on sides of the tooth 22 opposite to each other in the X-direction and respectively cover the side surfaces 22B of the tooth 22.

The insulator 16 is made of two parts: the first insulator 42 and the second insulator 44 separated from each other by the dividing portion 40 in the Z-direction. The dividing portion 40 refers to a boundary between the first insulator 42 and the second insulator 44. In other words, the dividing portion 40 serves as a boundary line defined between the first insulator 42 and the second insulator 44. The dividing portion 40 is located at the middle between the second insulating portions 32 in the Z-direction. Each of the second insulating portions 32 is divided or separated in the Z-direction into the upper second insulating portion 32A and the lower second insulating portion 32B by the dividing portion 40. Note that the expressions “upper side” and “lower side” in the upper second insulating portion 32A and the lower second insulating portion 32B are expressions for convenience, and do not limit the vertical direction of the stator 10.

The insulator 16 and the tooth 22 are configured to be symmetrical with respect to a plane extending in the X-direction. Hereinafter, regarding the insulator 16 and the tooth 22, a configuration on one side in the X-direction will be described, and a description of a configuration on the other side in the X-direction will be omitted for the sake of simplicity. Further, in the following description, the X1 side indicates one side in a tangential direction of the stator core 24, the X2 side indicates the other side in the tangential direction of the stator core 24, the Z1 side indicates one side in an axial direction of the stator core 24, and the Z2 side indicates the other side in the axial direction of the stator core 24.

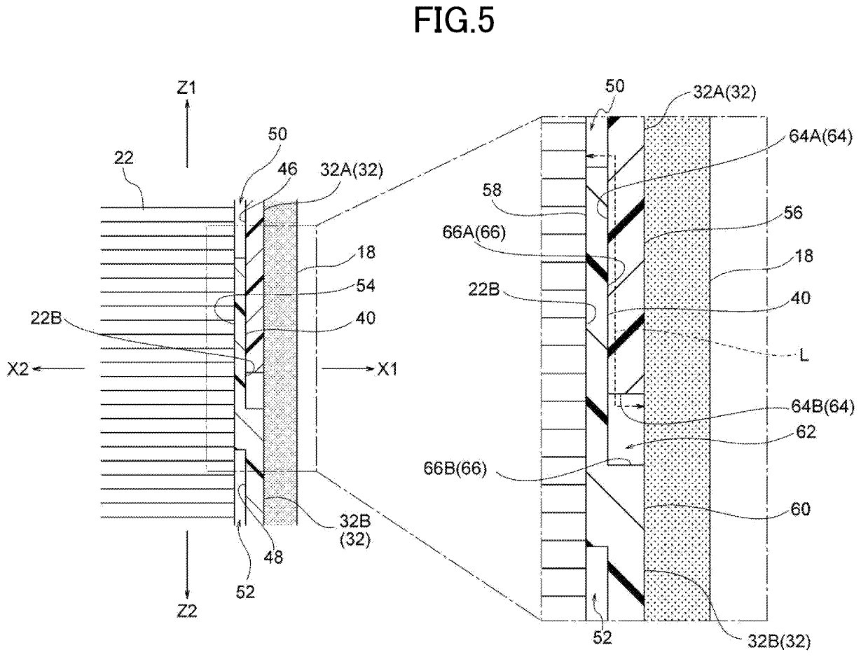

As shown in FIG. 5, each of the second insulating portions 32 has formed therein the first groove 46 and the second groove 48 opening toward the tooth 22. Between the second insulating portion 32 and the tooth 22, the first gas layer 50 is defined by the first groove 46, and the second gas layer 52 is defined by the second groove 48. The first gas layer 50 is provided between the upper second insulating portion 32A and the tooth 22 in the X-direction, and the second gas layer 52 is provided between the lower second insulating portion 32B and the tooth 22 in the X-direction. The first gas layer 50 and the second gas layer 52 are provided side by side in the Z-direction. The first gas layer 50 and the second gas layer 52 are examples of a “gas layer” or a “third gas layer” in the technology of the present disclosure.

Between the first gas layer 50 and the second gas layer 52 on the second insulating portion 32, the resin portion 54 is located. The resin portion 54 is formed as a contact portion that comes into physical contact with the side surface 22B of the tooth 22. The dividing portion 40 is defined in the resin portion 54. The dividing portion 40 communicates with the first gas layer 50. The dividing portion 40 may alternatively communicate with the second gas layer 52.

More specifically, the resin portion 54 has the overlap structure. The overlap structure is configured by the first overlapping portion 56 formed by the upper second insulating portion 32A and the second overlapping portion 58 formed by the lower second insulating portion 32B. The first overlapping portion 56 extends toward the Z2 side, while the second overlapping portion 58 extends toward the Z1 side. The dividing portion 40 is defined to pass between the first overlapping portion 56 and the second overlapping portion 58.

The first overlapping portion 56 is located closer to the wire-wound portion 18 (i.e., the X1 side) than the second overlapping portion 58 is and placed in contact with the wire-wound portion 18. The second overlapping portion 58 is located closer to the tooth 22 (i.e., the X2 side) than the first overlapping portion 56 is and placed in contact with the side surface 22B of the tooth 22.

The lower second insulating portion 32B has the second overlapping portion 58 and the main body 60. The main body 60 is located closer to the X1 side and the Z2 side than the second overlapping portion 58 is and aligned with the first overlapping portion 56 in the Z-direction via the gap 62.

The upper second insulating portion 32A has the first dividing surface 64 defining the dividing portion 40. The lower second insulating portion 32B has the second dividing surface 66 defining the dividing portion 40. Specifically, the boundary between the first dividing surface 64 and the second dividing surface 66 defines the dividing portion 40. The first dividing surface 64 includes the axial dividing surface 64A extending in the Z-direction and the tangential dividing surface 64B extending in the X-direction. The second dividing surface 66 includes the axial dividing surface 66A extending in the Z-direction and the tangential dividing surface 66B extending in the X-direction.

The axial dividing surface 64A and the axial dividing surface 66A separate the upper second insulating portion 32A and the lower second insulating portion 32B from each other in the X-direction. The tangential dividing surface 64B and the tangential dividing surface 66B separate the upper second insulating portion 32A and the lower second insulating portion 32B from each other in the Z-direction. The axial dividing surface 64A and the axial dividing surface 66A may be in contact with each other, or may alternatively be separated from each other with a gap. The tangential dividing surface 64B and the tangential dividing surface 66B are separated from each other with the gap 62, but may be in contact with each other.

As described above, the first gas layer 50 is arranged between the upper second insulating portion 32A and the tooth 22. Similarly, the second gas layer 52 is arranged between the lower second insulating portion 32B and the tooth 22. This layout secures a required degree of insulation between the tooth 22 and the wire-wound portion 18 without having to increase a thickness of the second insulating portion 32, as compared with a case where the first gas layer 50 and the second gas layer 52 are not provided. Thus, as compared with a case where the thickness of the second insulating portion 32 is increased, the insulation property with respect to the wire-wound portion 18 can be secured without reducing a space factor of the wire-wound portion 18. Further, since it is unnecessary to reduce the space factor of the wire-wound portion 18, an increase in a physical size of the stator 10 can be suppressed.

Further, between the first gas layer 50 and the second gas layer 52 of the second insulating portion 32, the resin portion 54 is, as described above, formed. The resin portion 54 has the overlap structure in which the first overlapping portion 56 formed by the upper second insulating portion 32A and the second overlapping portion 58 formed by the lower second insulating portion 32B overlap each other. The dividing portion 40 is formed passing between the first overlapping portion 56 and the second overlapping portion 58. Therefore, the creepage distance L defined by the dividing portion 40 is made long by an amount by which the dividing portion 40 extends between the first overlapping portion 56 and the second overlapping portion 58, thereby also securing insulation at the dividing portion 40. This ensures a required degree of insulation between the tooth and the wire-wound portion 18 without having to increase the size of the stator 10 as compared with a case of not having the overlap structure.

Further, the dividing portion 40 communicates with the first gas layer 50. In other words, the first gas layer 50 is interposed along the creepage distance L, thereby improving the insulation as compared with a case where the first gas layer 50 is not interposed.

Further, the main body 60 of the lower second insulating portion 32B is aligned with the first overlapping portion 56 in the Z-direction via the gap 62. The gap 62 also improves the insulation at the dividing portion 40.

Further, the resin portion 54 is in contact with the side surface 22B of the tooth 22, thereby suppressing the second insulating portion 32 from bending toward the tooth 22 due to a tightening force of the wire-wound portion 18. This avoids a decrease in widths of the first gas layer 50 and the second gas layer 52 in the Z-direction.

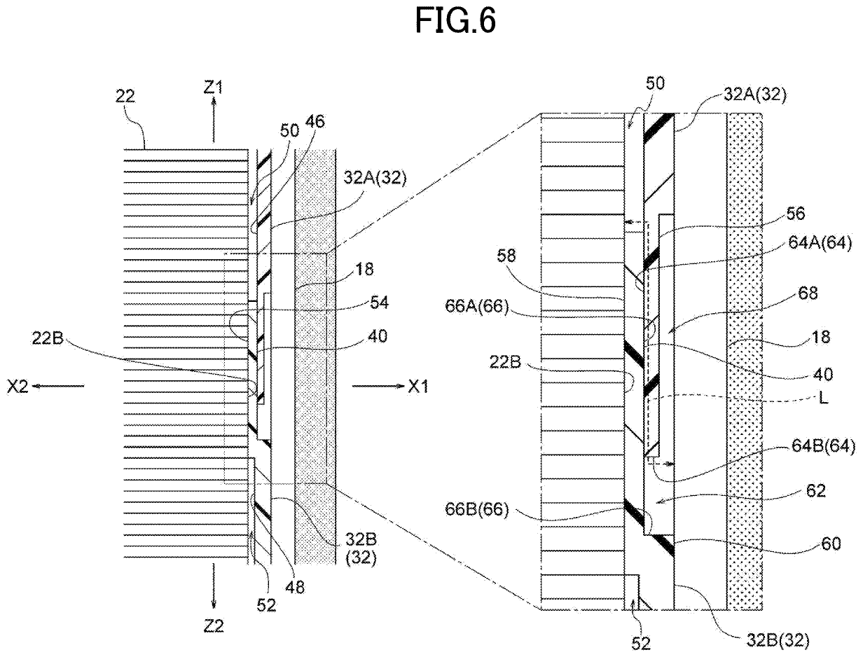

As shown in FIG. 6, the gap 68 may be provided between the first overlapping portion 56 and the wire-wound portion 18 in the X-direction. The gap 68 serves to improve the insulation at the wire-wound portion 18.

Further, the first overlapping portion 56 is located closer to the wire-wound portion 18 (i.e., the X1-side) than the second overlapping portion 58 is, however, the second overlapping portion 58 may be located closer to the wire-wound portion 18 (i.e., the X1-side) than the first overlapping portion 56 is.

### Second Embodiment

Next, the second embodiment of the technology in the present disclosure will be described.

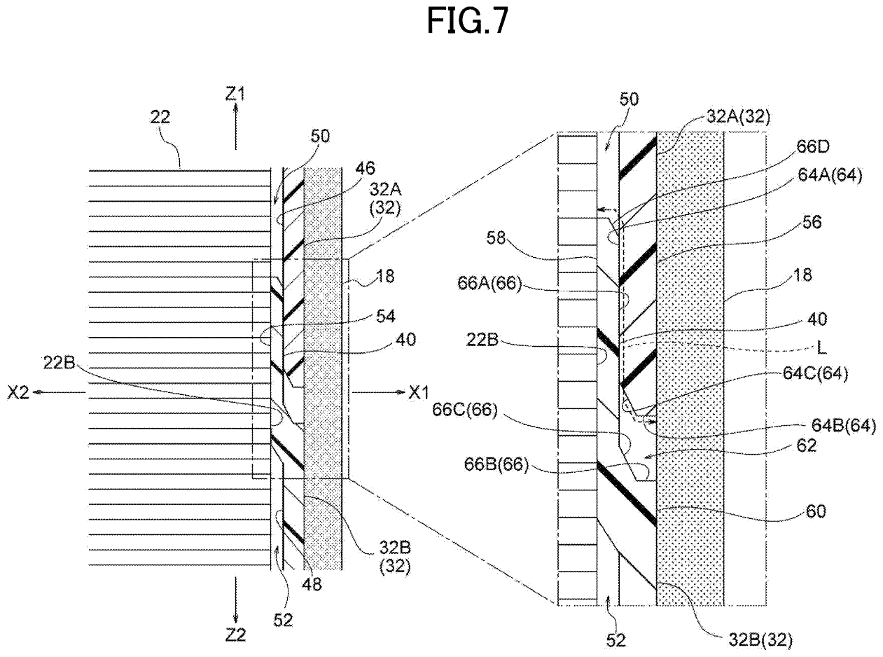

The second embodiment is different from the first embodiment only in the configuration of the insulator 16 of each of the stator core member 12. Specifically, as shown in FIG. 7, the first dividing surface 64 includes the axial dividing surface 64A extending in the Z-direction, the tangential dividing surface 64B extending in the tangential direction, and the inclined surface 64C. The inclined surface 64C extends between the axial dividing surface 64A and the tangential dividing surface 64B and is inclined at a given angle to the Z-direction. The inclined surface 64C may alternatively be regarded as a surface inclined with respect to the X-direction.

Similarly, the second dividing surface 66 includes the axial dividing surface 66A extending in the Z-direction, the tangential dividing surface 66B extending in the tangential direction, and the inclined surface 66C. The inclined surface 66C extends between the axial dividing surface 66A and the tangential dividing surface 66B and is inclined at a given angle to the Z-direction. The inclined surface 66C may alternatively be regarded as a surface inclined with respect to the X-direction. Further, the second overlapping portion 58 also has the inclined surface 66D formed on a corner of a tip end thereof.

The inclined surface 64C and the inclined surface 66D, as apparent from the above discussion, define portions of the creepage distance L, thereby resulting in an increase in the creepage distance L by amounts corresponding to the inclined surface 64C and the inclined surface 66D as compared with the above embodiment.

The creepage distance L may be defined by only the inclined surface 64C of the first dividing surface 64. In other words, the inclined surface 66C of the second dividing surface 66 may be omitted.

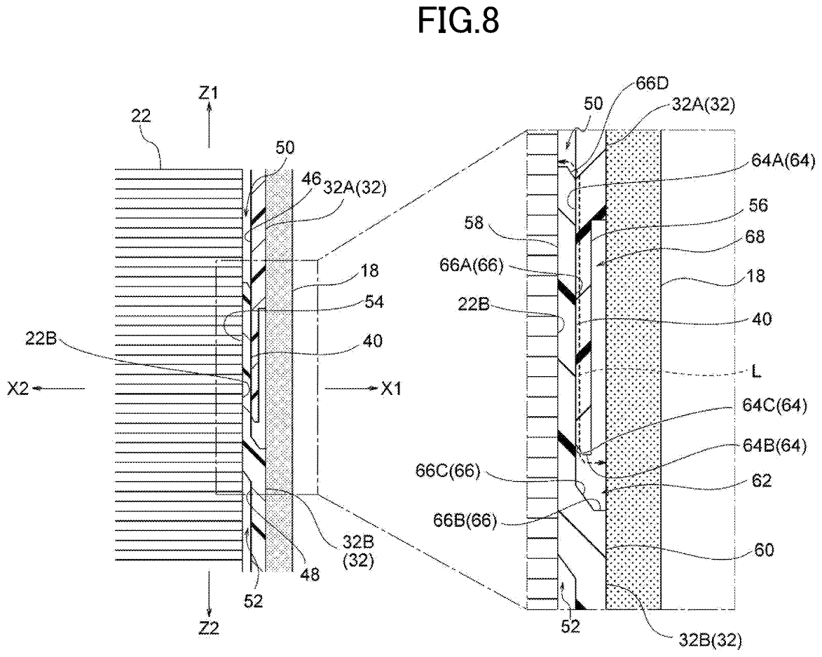

As shown in FIG. 8, the first overlapping portion 56 may have the gap 68 formed therein between the first overlapping portion 56 and the wire-wound portion 18 in the X-direction. The formation of the gap 68 serves to improve the insulation with respect to the wire-wound portion 18.

Further, although the first overlapping portion 56 is located closer to the wire-wound portion 18 (i.e., the X1-side) than the second overlapping portion 58 is, the second overlapping portion 58 may alternatively be located closer to the wire-wound portion 18 (i.e., the X1-side) than the first overlapping portion 56 is. In this layout, an inclined surface defining a portion of the creepage distance L may be formed on the second overlapping portion 58.

Further, other configurations (including modified examples) of the first embodiment may be combined with the second embodiment.

### Third Embodiment

The third embodiment in this disclosure will be described below.

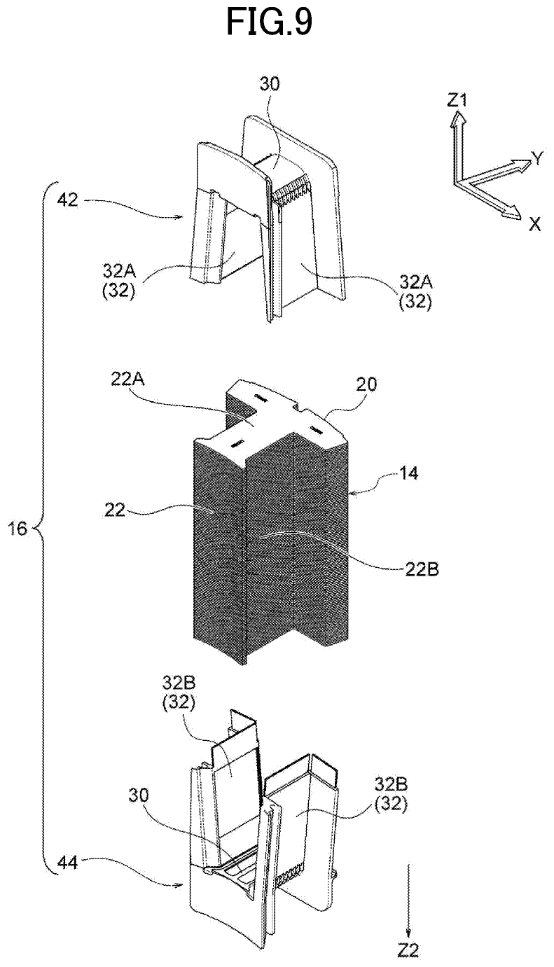

The third embodiment is different from the first embodiment only in the configuration of the insulator 16. Specifically, as shown in FIG. 9, before attachment to the tooth 22, a pair of upper second insulating portions 32A arranged on the Z1-side are formed in a tapered shape such that an interval therebetween widens toward the Z2-side. On the other hand, before attachment to the tooth 22, a pair of lower second insulating portions 32B arranged on the Z2-side are formed in a tapered shape such that an interval therebetween increases toward the Z1-side.

After attachment to the tooth 22, the pair of upper second insulating portions 32A and the pair of lower second insulating portions 32B are pressed toward the tooth 22 by the wire-wound portion 18. A manner in which the pair of upper second insulating portions 32A and the pair of lower second insulating portions 32B are pressed toward the tooth 22 by the wire-wound portion 18 is similar to that in FIG. 2.

In the third embodiment, each of the first insulating portions 30 of the first insulator 42 corresponds to a “first insulating portion” in the technology of the present disclosure, the pair of upper second insulating portions 32A of the first insulator 42 correspond to a “pair of second insulating portions” in the technology of the present disclosure, the first insulating portion 30 of the second insulator 44 corresponds to a “third insulating portion” in the technology of the present disclosure, and the pair of lower second insulating portions 32B of the second insulator 44 corresponds to a “pair of fourth insulating portions” in the technology of the present disclosure.

As described above, the pair of upper second insulating portions 32A are formed in a tapered shape such that the interval therebetween increases toward the Z2-side before attachment to the tooth 22, thereby avoiding physical interference of the upper second insulating portions 32A with the tooth 22 when the upper second insulating portions 32A are attached to the tooth 22. This facilitates the securement of the upper second insulating portions 32A to the tooth 22.

Similarly, before attachment to the tooth 22, the pair of lower second insulating portions 32B are formed in a tapered shape such that an interval therebetween increases toward the Z1-side, thereby avoiding physical interference of the lower second insulating portions 32B with the tooth 22 when the lower second insulating portions 32B are attached to the tooth 22. This facilitates the securement of the lower second insulating portions 32B to the tooth 22.

Further, other configurations (including modified examples) of the first and second embodiments may be combined with the third embodiment.

### Fourth Embodiment

Next, the fourth embodiment of the technology of the present disclosure will be described.

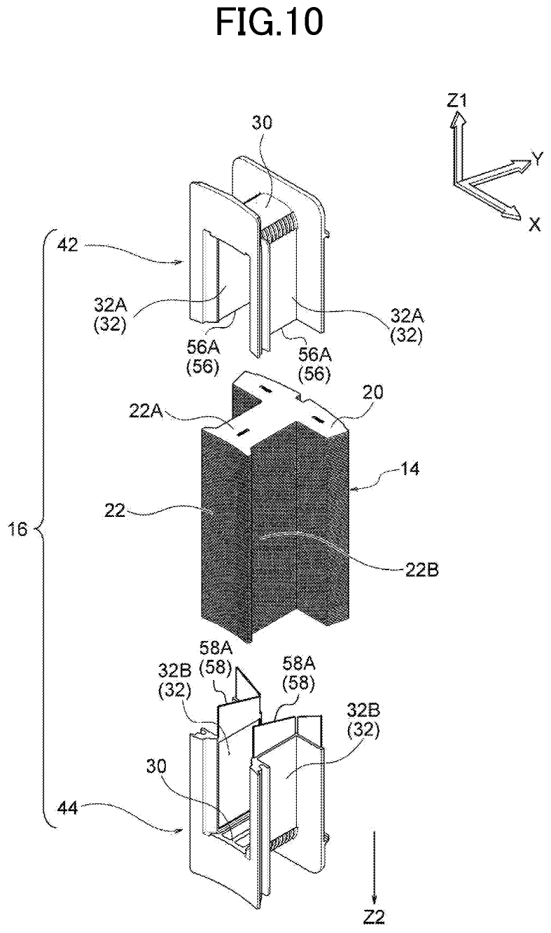

The fourth embodiment is different from the first embodiment only in the configuration of the insulator 16. Specifically, as shown in FIG. 10, each of the second overlapping portions 58 has the tip 58A inclined with respect to the Y-direction when viewed from the X-direction.

The tip 58A of each of the second overlapping portions 58 is, as described above, inclined with respect to the Y-direction when viewed from the X-direction, thereby facilitating insertion of the pair of second overlapping portions 58 into the first overlapping portions 56 when the first insulator 42 and the second insulator 44 are attached to each other in the Z-direction, as compared with a case where the tip 58A of each of the second overlapping portions 58 is parallel to the Y-direction when viewed from the X-direction.

Instead of the tips 58A of the second overlapping portions 58 being inclined with respect to the Y-direction when viewed from the X-direction, the tips 56A of the first overlapping portions 56 of the first insulator 42 may be inclined with respect to the Y-direction when viewed from the X-direction.

The inclination of tips 56A of the first overlapping portions 56 with respect to the Y-direction when viewed from the X-direction facilitates the insertion of the pair of second overlapping portions 58 into the first overlapping portions 56 when the first insulator 42 and the second insulator 44 are attached to each other in the Z-direction, as compared with a case where the tips 56A of the first overlapping portions 56 are parallel to the Y-direction when viewed from the X-direction.

Further, the first overlapping portions 56 may be configured to be inserted into the second overlapping portions 58. In this case, the tips 56A of the first overlapping portions 56 or the tips 58A of the second overlapping portions 58 are preferably inclined relative to the Y-direction when viewed from the X-direction. This structure provides substantially the same effects as those in the above-described structure.

Further, other configurations (including modified examples) in the first to third embodiments may be combined with the fourth embodiment.

### Fifth Embodiment

Next, the fifth embodiment of the technology of the present disclosure will be described.

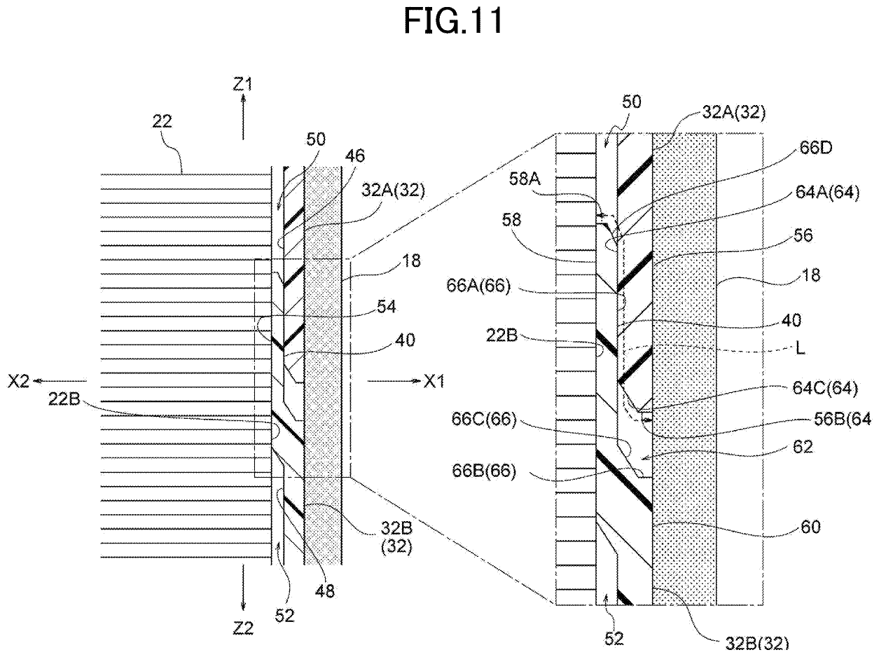

The fifth embodiment is different from the first embodiment only in the configuration of the insulator 16. Specifically, as shown in FIG. 11, the insulator 16 is designed to have a configuration combining the configurations of the fourth embodiment and the second embodiment.

Specifically, the first dividing surface 64 has the axial dividing surface 64A extending in the Z-direction, the tangential dividing surface 64B extending in a tangential direction, and the inclined surface 64C. The second dividing surface 66 has the axial dividing surface 66A extending in the Z-direction, the tangential dividing surface 66B extending in the tangential direction of the stator core 24, and the inclined surface 66C. The inclined surface 66D is formed on a corner of the tip 58A of the second overlapping portion 58. The tip 58A of the second overlapping portion 58 is inclined with respect to the Y-direction when viewed from the X-direction (see FIG. 10).

The insulator 16 has the configuration in which the configuration of the second embodiment is combined with the configuration in the fourth embodiment, thereby securing the creepage distance L defined by the dividing portion 40 long and facilitating the insertion of the second overlapping portions 58 into the first overlapping portions 56 when the first insulator 42 and the second insulator 44 are combined with each other in the Z-direction.

Note that other configurations (including modified examples) in the first to fourth embodiments may be combined with the fifth embodiment.

### Sixth Embodiment

Next, the sixth embodiment of the technology of the present disclosure will be described.

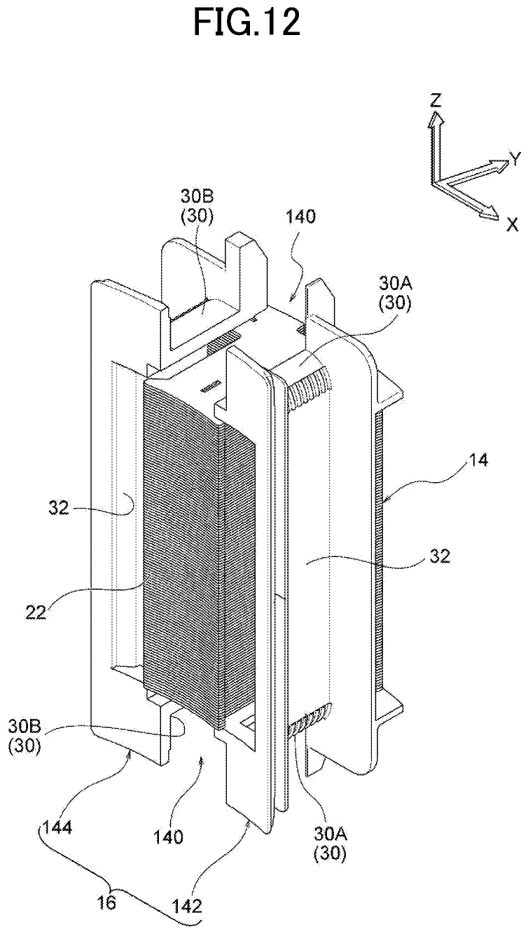

The sixth embodiment is different from the first embodiment only in the configuration of the insulator 16. Specifically, as shown in FIG. 12, the insulator 16 includes two lateral ports: the first insulator 142 and the second insulator 144 which are arranged adjacent to each other through the dividing portion 140. The dividing portion 140 is formed at the middle between the first insulating portions 30 in the X-direction. The first insulating portions 30 include the right first insulating portion 30A and the left first insulating portion 30B separate from each other through the dividing portion 140 in the X-direction. Note that the expressions “right side” and “left side” in the right first insulating portion 30A and the left first insulating portion 30B are expressions for convenience, and do not limit the left-right direction of the stator 10.

The insulator 16 and the tooth 22 are configured to be symmetrical with respect to a plane in the Z-direction. Hereinafter, regarding the insulator 16 and the tooth 22, a configuration on one side in the Z-direction will be described, and a description of a configuration on the other side in the Z-direction will be omitted. Further, in the following description, the X1-side indicates one side in the tangential direction of the stator core 24, the X2-side indicates the other side in the tangential direction of the stator core 24, the Z1-side indicates one side in an axial direction of the stator core 24, and the Z2-side indicates the other side in the tangential direction of the stator core 24.

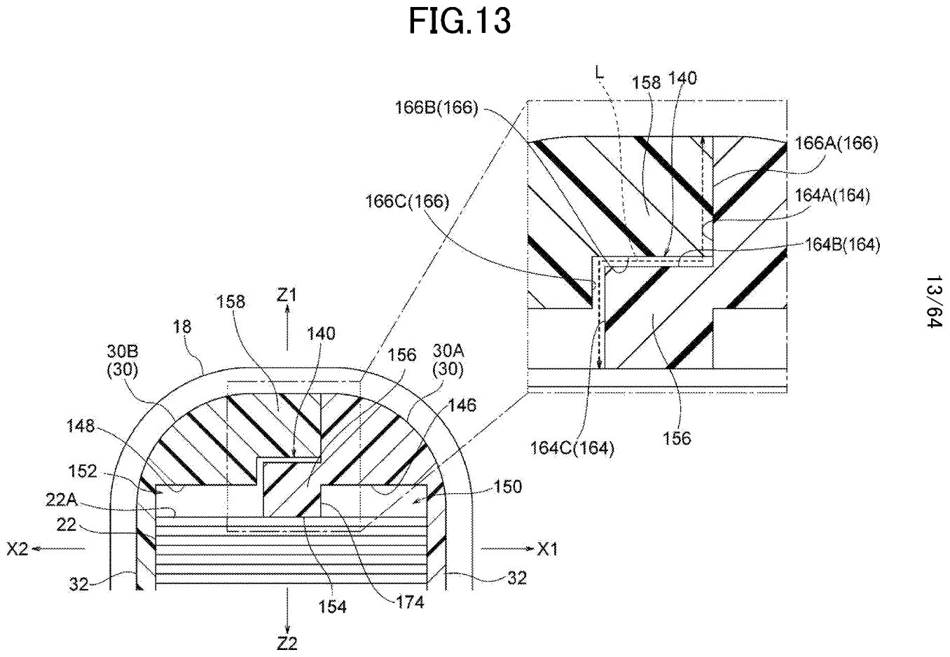

As shown in FIG. 13, the first insulating portion 30 has formed therein the first groove 146 and the first groove 148 opening at the tooth 22. Between the first insulating portion 30 and the tooth 22, the first gas layer 150 is defined by the first groove 146, and the second gas layer 152 is defined by the first groove 148. The first gas layer 150 lies between the right first insulating portion 30A and the tooth 22 in the Z-direction. The second gas layer 152 lies between the left first insulating portion 30B and the tooth 22 in the Z-direction. The first gas layer 150 and the second gas layer 152 are provided side by side in the X-direction. The first gas layer 150 and the second gas layer 152 are examples of a “gas layer” and a “third gas layer” in the technology of the present disclosure.

The resin portion 154 functions as a contact portion that comes into contact with the end face 22A of the tooth 22. The dividing portion 140 is formed in the resin portion 154. The dividing portion 140 communicates only with the second gas layer 152. The dividing portion 140 may alternatively communicate with the first gas layer 150.

More specifically, the resin portion 154 has the overlap structure. The overlap structure is configured by the first overlapping portion 156 formed by a portion of the right first insulating portion 30A, and the second overlapping portion 158 formed by a portion of the left first insulating portion 30B. The first overlapping portion 156 extends from the main body of the right first insulating portion 30A toward the X2-side. The second overlapping portion 158 extends from the main body of the left first insulating portion 30B toward the X1-side. The dividing portion 140 passes between the first overlapping portion 156 and the second overlapping portion 158.

The first overlapping portion 156 is located closer to the tooth 22 (i.e., the Z2-side) than the second overlapping portion 158 is. The first overlapping portion 156 has the protrusion 174 protruding toward the tooth 22. The protrusion 174 is in contact with the end face 22A of the tooth 22. The protrusion 174 is arranged between the first gas layer 150 and the second gas layer 152 in the X-direction. The second overlapping portion 158 is located closer to the wire-wound portion 18 (i.e., the Z1-side) than the first overlapping portion 156 is, and is in physical contact with the wire-wound portion 18.

The right first insulating portion 30A has the first dividing surface 164 defining the dividing portion 140. Similarly, the left first insulating portion 30B has the second dividing surface 166 defining the dividing portion 140. A boundary between the first dividing surface 164 and the second dividing surface 166 is defined by the dividing portion 140. The first dividing surface 164 has the first axial dividing surface 164A extending in the Z-direction, the tangential dividing surface 164B extending in the X-direction, and the second axial dividing surface 164C extending in the Z-direction. Similarly, the second dividing surface 166 has the first axial dividing surface 166A extending in the Z-direction, the tangential dividing surface 166B extending in the X-direction, and the second axial dividing surface 166C extending in the Z-direction.

The first axial dividing surface 164A and the first axial dividing surface 166A divide the right first insulating portion 30A and the left first insulating portion 30B in the X-direction. The tangential dividing surface 164B and the tangential dividing surface 166B divide the right first insulating portion 30A and the left first insulating portion 30B in the Z-direction. Further, the second axial dividing surface 164C and the second axial dividing surface 166C divide the right first insulating portion 30A and the left first insulating portion 30B in the X-direction. The first axial dividing surface 164A and the first axial dividing surface 166A are in contact with each other, but may be separated from each other with a gap. The tangential dividing surface 164B and the tangential dividing surface 166B are separated from each other with a gap, but may be in contact with each other. The second axial dividing surface 164C and the second axial dividing surface 166C are separated from each other with a gap, but may be in contact with each other.

The first gas layer 150 arranged between the right first insulating portion 30A and the tooth 22 and the second gas layer 152 arranged between the left first insulating portion 30B and the tooth 22 serve to secure insulation with respect to the wire-wound portion 18 without having to increase the thickness of the first insulating portion 30, as compared with a case where the first gas layer 150 and the second gas layer 152 are not provided. Thus, as compared with a case where the thickness of the first insulating portion 30 is increased, the insulation property with respect to the wire-wound portion 18 is secured while suppressing an increase in a physical size of the stator 10 in the Z-direction.

Further, the first insulating portion 30 has the resin portion 154 arranged between the first gas layer 150 and the second gas layer 152. The resin portion 154 has the overlap structure in which the first overlapping portion 156 formed by a portion of the right first insulating portion 30A and the second overlapping portion 158 formed by a portion of the left first insulating portion 30B overlap each other. The dividing portion 140 passes between the first overlapping portion 156 and the second overlapping portion 158. Therefore, since the creepage distance L defined by the dividing portion 140 is increased by an amount corresponding to the dividing portion 140 passing between the first overlapping portion 156 and the second overlapping portion 158, insulation at the dividing portion 140 is also ensured. This makes it possible to establish a required degree of insulation with respect to the wire-wound portion 18 without increasing the physical size of the stator 10, as compared with a case where the overlap structure is not provided.

Further, the dividing portion 140 communicates with the first gas layer 150. In other words, the first gas layer 150 is interposed along the creepage distance L, thereby enhancing the insulation as compared with a case where the first gas layer 150 is not interposed.

Further, the protrusion 174 is formed on the first overlapping portion 156 and placed in contact with the end face 22A of the tooth 22. This prevents the second insulating portion 32 from bending toward the tooth 22 due to a tightening force generated by the wire-wound portion 18. This avoids a decrease in widths of the first gas layer 150 and the second gas layer 152 in the Z-direction.

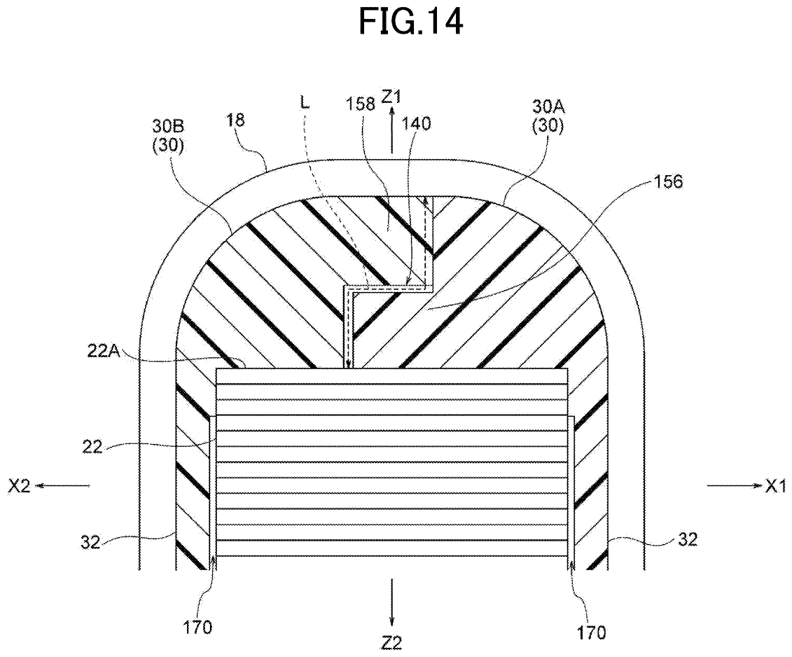

The first gas layer 150 and the second gas layer 152 lying between the first insulating portions 30 and the tooth 22 may be, as illustrated in FIG. 14, omitted, while the gas layer 170 may be arranged between each of the second insulating portion 32 and the tooth 22. The gas layers 170 are an example of a “third gas layer” in the technology of the present disclosure.

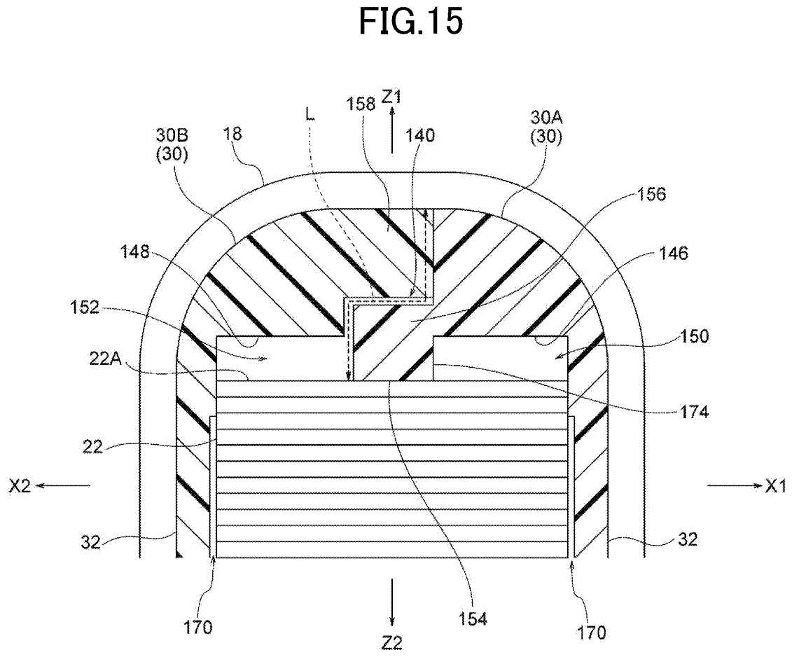

The first gas layer 150 and the second gas layer 152 may be, as illustrated in FIG. 15, arranged between the first insulating portions 30 and the tooth 22. The gas layer 170 may be formed between each of the second insulating portion 32 and the tooth 22.

Further, although the second overlapping portion 158 is located closer to the wire-wound portion 18 (i.e., the Z1-side) than the first overlapping portion 156 is, the first overlapping portion 156 may alternatively be located closer to the wire-wound portion 18 (i.e., the Z1-side) than the second overlapping portion 158 is.

### Seventh Embodiment

Next, the seventh embodiment of the technology of the present disclosure will be described.

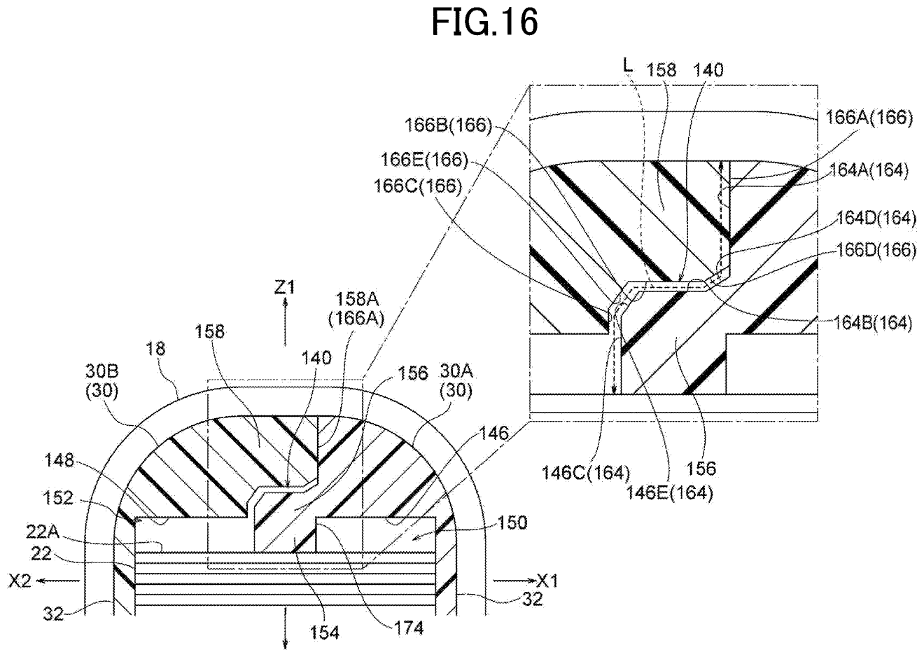

The seventh embodiment is different from the sixth embodiment only in the configuration of the insulator 16. Specifically, as shown in FIG. 16, the first dividing surface 164 includes the first axial dividing surface 164A extending in the Z-direction, the tangential dividing surface 164B extending in the tangential direction, the second axial dividing surface 164C extending in the Z-direction, the first inclined surface 164D, and the second inclined surface 164E. The first inclined surface 164D extends to connect the first axial dividing surface 164A and the tangential dividing surface 164B together and is inclined relative to the X-direction. The second inclined surface 164E extend to connect the second axial dividing surface 164C and the tangential dividing surface 164B together and is inclined relative to the X-direction. Note that the first inclined surface 164D and the second inclined surface 164E may be regarded as surfaces inclined with respect to the Z-direction.

The second dividing surface 166 includes the first axial dividing surface 166A extending in the Z-direction, the tangential dividing surface 166B extending in the tangential direction, the second axial dividing surface 166C extending in the Z-direction, the first inclined surface 166D, and the second inclined surface 166E. The first inclined surface 166D extends to connect the first axial dividing surface 166A and the tangential dividing surface 166B together and is inclined relative to the X-direction. The second inclined surface 166E extends to connect between the second axial dividing surface 166C and the tangential dividing surface 166B and is inclined relative to the X-direction. Note that the first inclined surface 166D and the second inclined surface 166E may be regarded as surfaces inclined with respect to the Z-direction.

As apparent from the above discussion, the first inclined surface 164D, the second inclined surface 164E, the first inclined surface 166D, and the second inclined surface 166E define portions of the creepage distance L, thereby increasing the creepage distance L by an amount corresponding to the first inclined surface 164D, the second inclined surface 164E, the first inclined surface 166D, and the second inclined surface 166E being formed.

Note that among the first inclined surface 164D, the second inclined surface 164E, the first inclined surface 166D, and the second inclined surface 166E, any inclined surface that does not define the creepage distance L may be omitted.

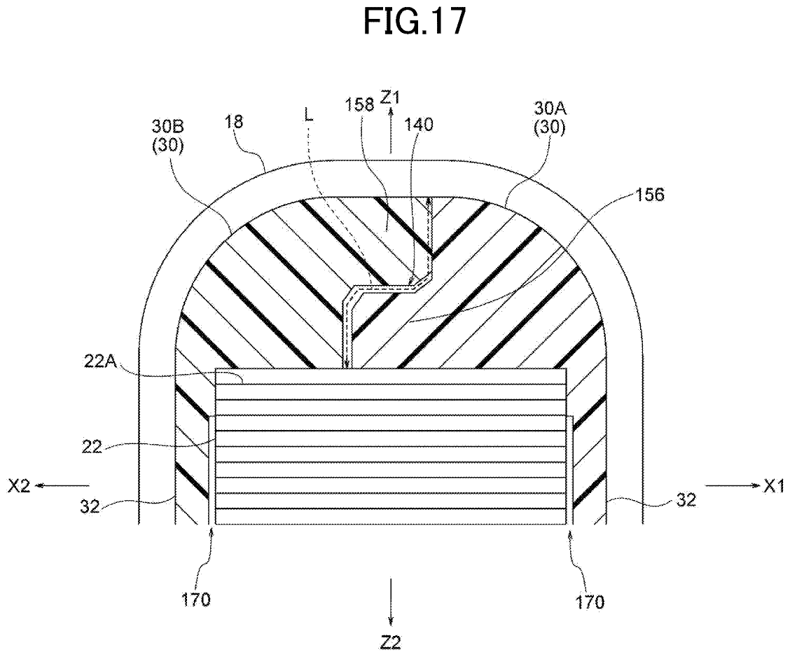

As shown in FIG. 17, the first gas layer 150 and the second gas layer 152 disposed between the first insulating portions 30 and the tooth 22 may be omitted, while the gas layers 170 may be provided between the second insulating portions 32 and the tooth 22.

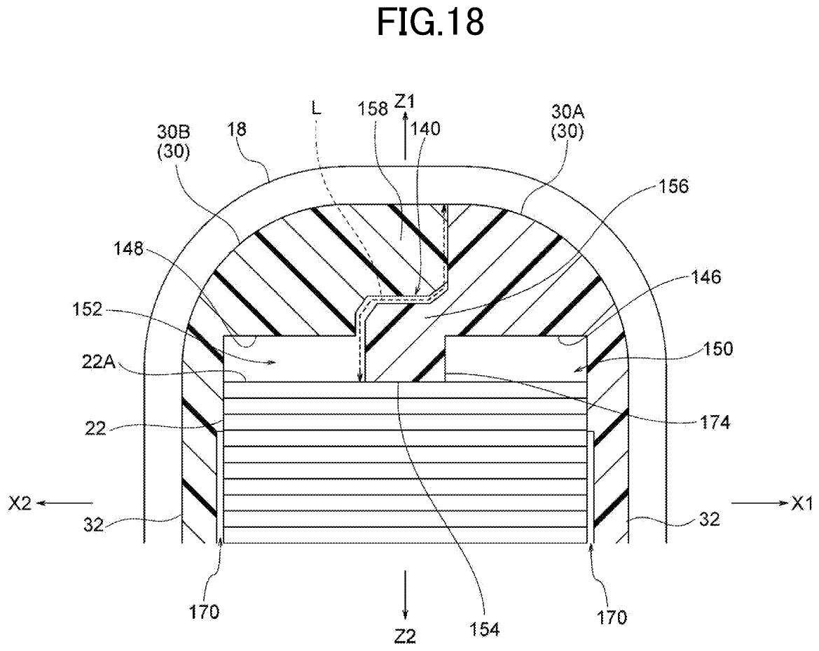

As shown in FIG. 18, the first gas layer 150 and the second gas layer 152 may be arranged between the first insulating portions 30 and the tooth 22, and the gas layers 170 may be formed between the second insulating portions 32 and the tooth 22.

Further, other configurations (including modified examples) in the sixth embodiment may be combined with the seventh embodiment.

### Eighth Embodiment

Next, the eighth embodiment of the technology of the present disclosure will be described.

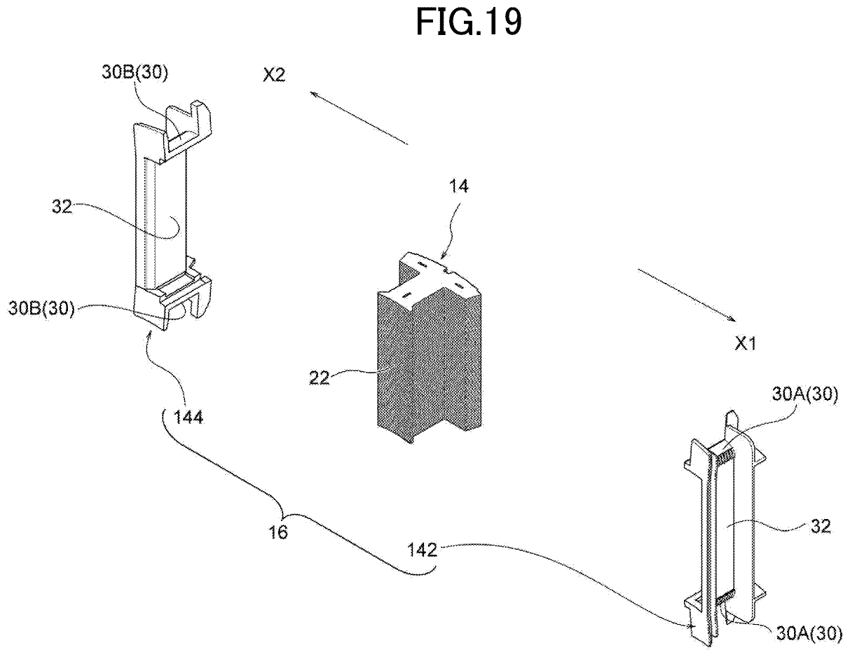

The eighth embodiment is different from the sixth embodiment only in the configuration of the insulator 16. Specifically, as shown in FIG. 19, before attachment to the tooth 22, the pair of right first insulating portions 30A arranged closer to the X1-side is formed in a tapered shape such that an interval therebetween increases toward the X2-side. On the other hand, before attachment to the tooth 22, the pair of left first insulating portions 30B arranged closer to the X2-side is formed in a tapered shape such that an interval therebetween increases toward the X1-side.

After attachment to the tooth 22, the pair of right first insulating portions 30A and the pair of left first insulating portions 30B are pressed toward the tooth 22 by the wire-wound portion 18. A manner in which the pair of right first insulating portions 30A and the pair of left first insulating portions 30B are pressed toward the tooth 22 by the wire-wound portion 18 is similar to that in FIG. 13.

Note that, in the eighth embodiment, the second insulating portion 32 of the first insulator 142 is an example of a “first insulating portion” in the technology of the present disclosure, the pair of right first insulating portions 30A of the first insulator 142 is an example of a “pair of second insulating portions” in the technology of the present disclosure, the second insulating portion 32 of the second insulator 144 is an example of a “third insulating portion” in the technology of the present disclosure, and the pair of left first insulating portions 30B of the second insulator 144 is an example of a “pair of fourth insulating portions” in the technology of the present disclosure.

The right first insulating portions 30A are, as described above, formed in a tapered shape such that the interval therebetween widens toward the X2-side before being attached to the tooth 22, thereby avoiding physical interference between the right first insulating portions 30A and the tooth 22 when the right first insulating portions 30A are attached to the tooth 22. This facilitates attachment of the right first insulating portions 30A to the tooth 22.

Similarly, the left first insulating portions 30B are formed in a tapered shape such that the interval therebetween widens toward the X1-side before being attached to the tooth 22, thereby avoiding interference between the left first insulating portions 30B and the tooth 22 when the left first insulating portions 30B are attached to the tooth 22. This facilitates attachment of the left first insulating portions 30B to the tooth 22.

Note that other configurations (including modified examples) in the sixth and seventh embodiments may be combined with the eighth embodiment.

### Ninth Embodiment

Next, the ninth embodiment of the technology of the present disclosure will be described.

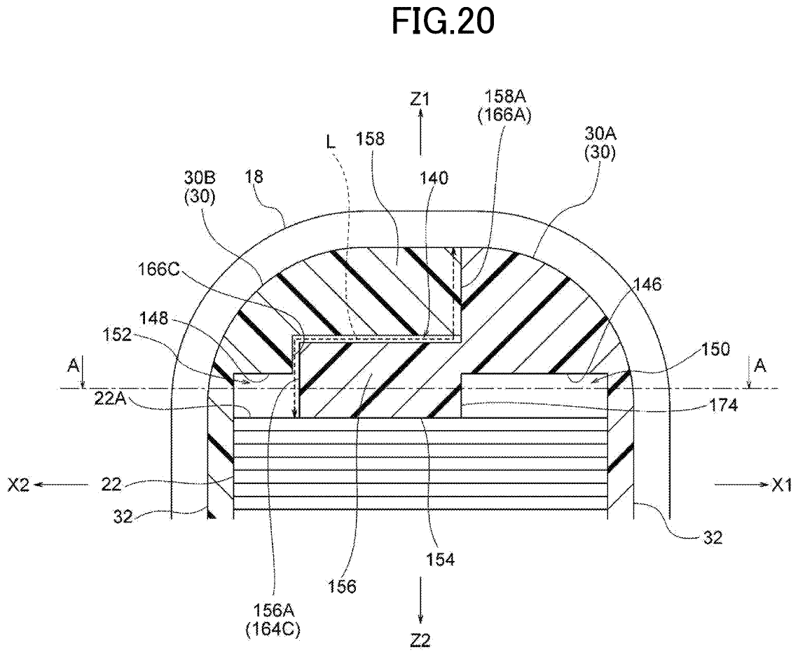

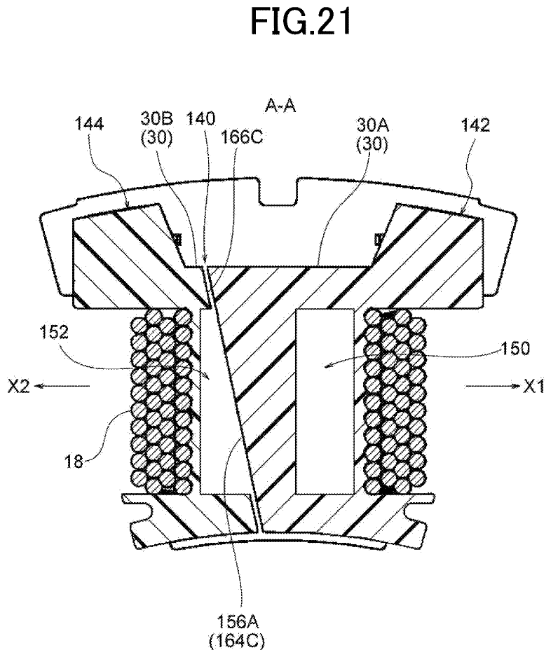

The ninth embodiment is different from the sixth embodiment in the configuration of the insulator 16. Specifically, as shown in FIGS. 20 and 21, the tip 156A of the first overlapping portion 156 (that is, the second axial dividing surface 164C) of each of the first insulating portions 30 is inclined relative to the Y-direction when viewed from the Z-direction. Further, the second axial dividing surface 166C facing the tip 156A of the first overlapping portion 156 is also inclined at angle substantially identical to that of the second axial dividing surface 164C.

The tip 156A of each of the first overlapping portions 156 is, as described above, inclined relative to the Y-direction when viewed from the Z-direction, thereby facilitating insertion of the first overlapping portions 156 into the second overlapping portions 158 when combining the first insulator 142 and the second insulator 144 in the X-direction, as compared with a case where the tips 156A of the first overlapping portions 156 are parallel to the Y-direction when viewed from the Z-direction.

Note that instead of the tips 156A of the first overlapping portions 156 being inclined relative to the Y-direction when viewed from the Z-direction, the tips 158A of the second overlapping portions 158 (that is, the first axial dividing surfaces 166A) may be inclined relative to the Y-direction when viewed from the Z-direction.

When the tips 158A of the second overlapping portions 158 are inclined relative to the Y-direction when viewed from the Z-direction, it facilitates insertion of the first overlapping portions 156 into the second overlapping portions 158 when combining the first insulator 142 and the second insulator 144 in the X-direction, as compared with a case where the tips 158A of the second overlapping portions 158 are parallel to the Y-direction when viewed from the Z-direction.

Further, in a configuration in which the second overlapping portions 158 are inserted into the first overlapping portions 156, the tips 156A of the first overlapping portions 156 or the tips 158A of the second overlapping portions 158 may be inclined relative to the Y-direction when viewed from the Z-direction. This configuration also provides substantially the same effects as described above.

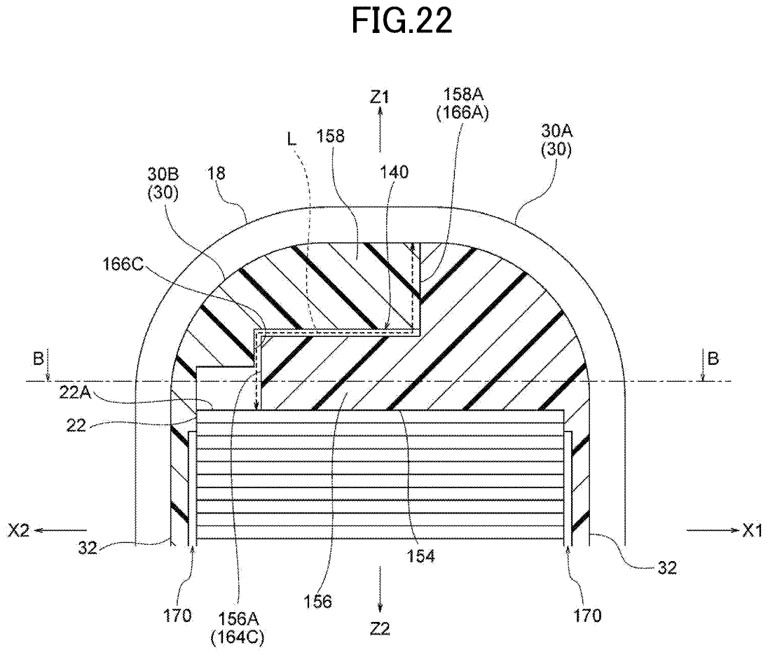

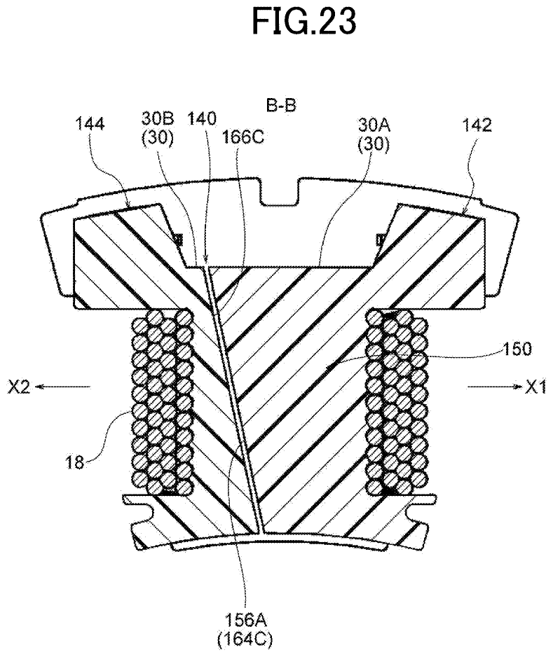

As shown in FIGS. 22 and 23, the first gas layer 150 and the second gas layer 152 arranged between the first insulating portion 30 and the tooth 22 may be omitted, and the gas layers 170 may be created between the second insulating portions 32 and the tooth 22.

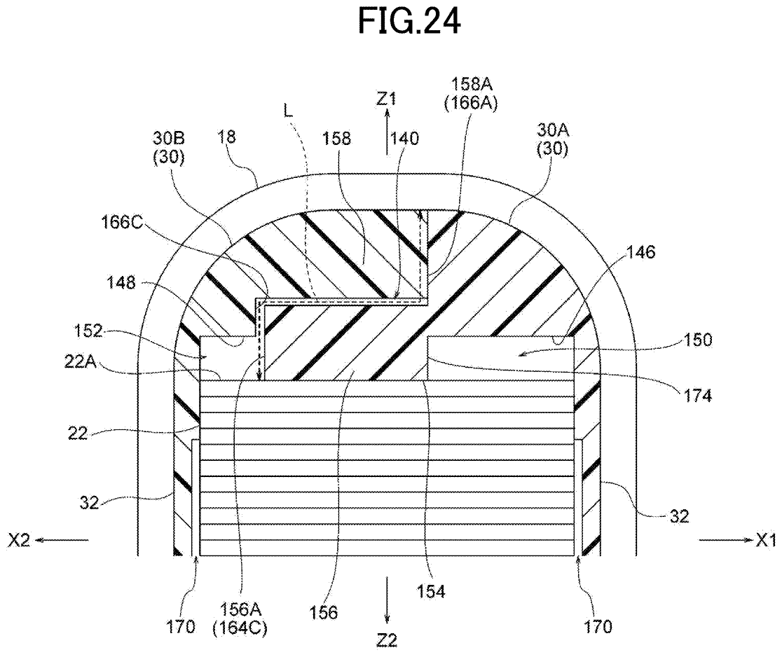

As shown in FIG. 24, the first gas layer 150 and the second gas layer 152 may be formed between the first insulating portions 30 and the tooth 22, and the gas layer 170 may be arranged between the second insulating portions 32 and the tooth 22.

Further, other configurations (including modified examples) in the sixth to eighth embodiments may be combined with the ninth embodiment.

### Tenth Embodiment

Next, the tenth embodiment of the technology of the present disclosure will be described.

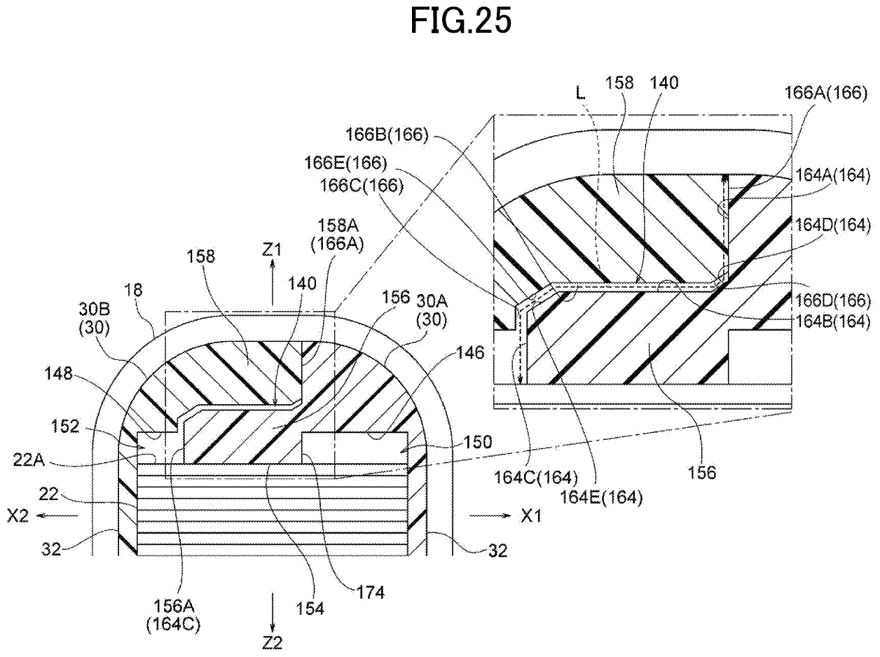

The tenth embodiment is different from the sixth embodiment in the configuration of the insulator 16. Specifically, as shown in FIG. 25, the insulator 16 has a configuration combining the configurations of the ninth embodiment and the seventh embodiment.

Specifically, the first dividing surface 164 includes the first axial dividing surface 164A extending in the Z-direction, the tangential dividing surface 166B extending in the tangential direction, the second axial dividing surface 164C extending in the Z-direction, the first inclined surface 164D, and the second inclined surface 164E. The second dividing surface 166 includes the first axial dividing surface 166A extending in the Z-direction, the tangential dividing surface 166B extending in the tangential direction, the second axial dividing surface 166C extending in the Z-direction, the first inclined surface 166D, and the second inclined surface 166E. The tip 156A of the first overlapping portion 156 (that is, the second axial dividing surface 164C) is inclined relative to the Y-direction when viewed from the Z-direction (see FIG. 21).

The insulator 16, as described above, has the configuration in which the configuration of the ninth embodiment is combined with the configuration of the seventh embodiment, thereby facilitating insertion of the first overlapping portions 156 into the second overlapping portions 158 when combining the first insulator 142 and the second insulator 144 in the X-direction, while increasing the creepage distance L defined by the dividing portion 140.

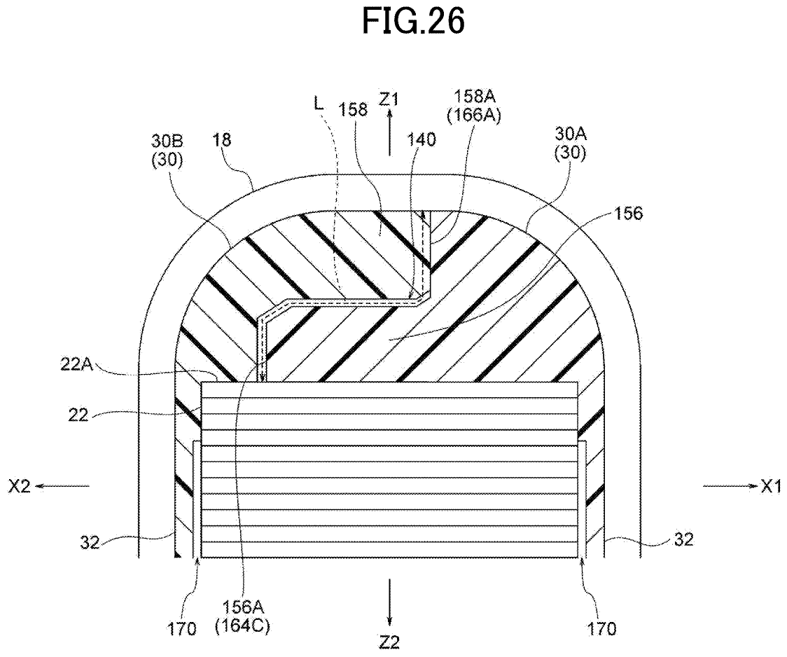

As shown in FIG. 26, the first gas layer 150 and the second gas layer 152 arranged between the first insulating portions 30 and the tooth 22 may be omitted, and the gas layers 170 may be provided between the second insulating portions 32 and the tooth 22.

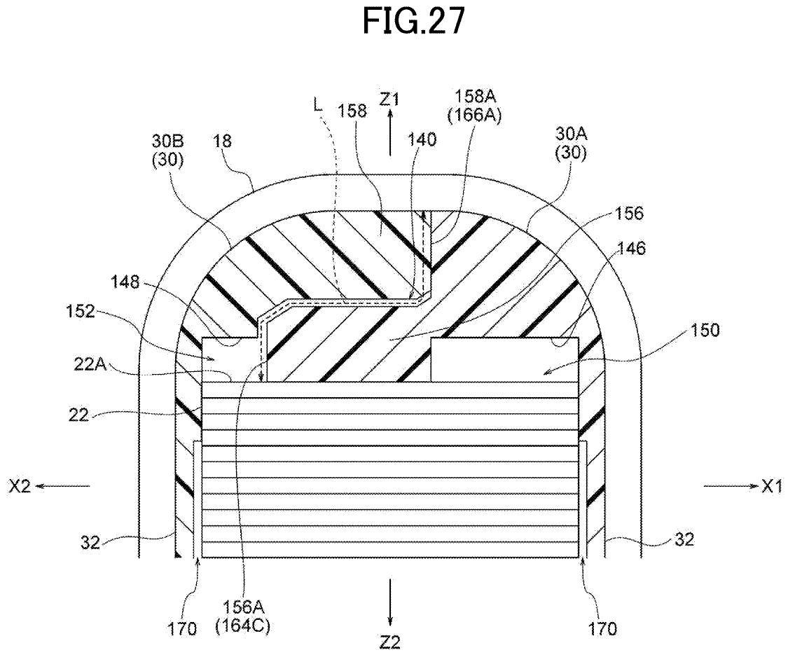

As shown in FIG. 27, the first gas layer 150 and the second gas layer 152 may be disposed between the first insulating portions 30 and the tooth 22, and the gas layers 170 may be disposed between the second insulating portions 32 and the tooth 22.

Further, other configurations (including modified examples) in the sixth to ninth embodiments may be combined with the tenth embodiment.

### Eleventh Embodiment

Next, the eleventh embodiment of the technology of the present disclosure will be described.

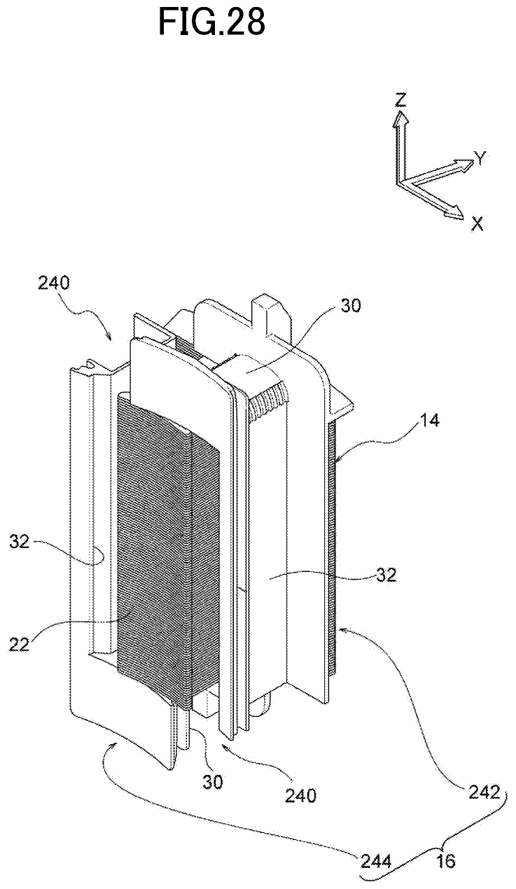

The eleventh embodiment is different from the first embodiment in the configuration of the insulator 16. Specifically, as shown in FIG. 28, the insulator 16 includes the first insulator 242 and the second insulator 244 which are separated by the dividing portion 240 from each other in the X-direction and the Z-direction. The dividing portions 240 are formed between the first insulating portions 30 and the second insulating portions 32.

The insulator 16 and the tooth 22 are configured to be point-symmetric around the Y-direction. Hereinafter, regarding the insulator 16 and the tooth 22, a configuration around one of the dividing portions 240 will be described, and the description of a configuration around the other dividing portion 240 will be omitted. Further, in the following description, the X1-side indicates one side in the tangential direction of the stator core 24, the X2-side indicates the other side in the tangential direction of the stator core 24, the Z1-side indicates one side in an axial direction of the stator core 24, and the Z2-side indicates the other side in the tangential direction of the stator core 24.

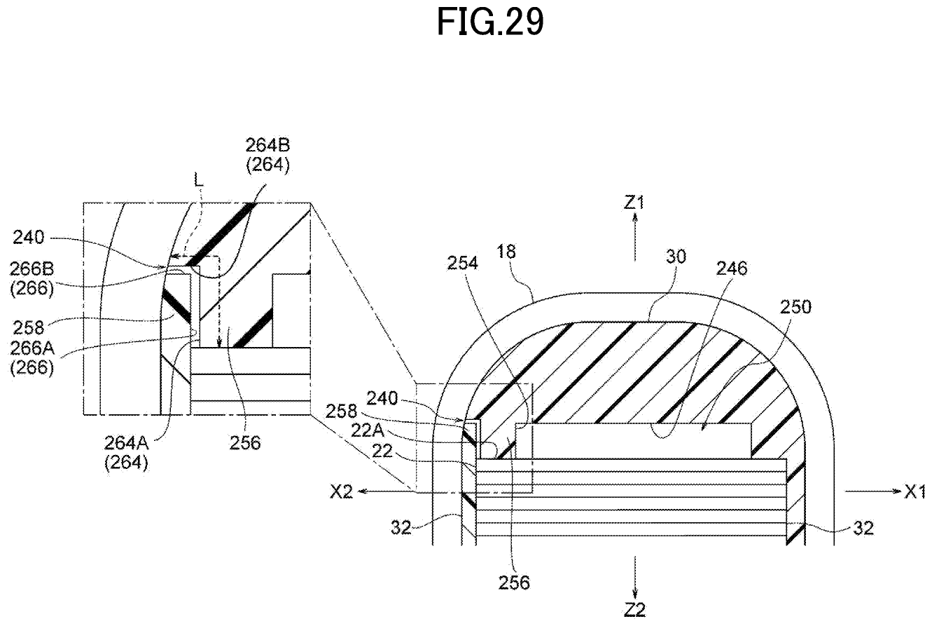

As shown in FIG. 29, each of the first insulating portions 30 has the groove 246 opening toward the tooth 22. The groove 246 defines the gas layer 250 between the first insulating portion 30 and the tooth 22 in the Z-direction. The gas layer 250 is an example of a “third gas layer” in the technology of the present disclosure. The first insulating portion 30 has the resin portion 254 formed between itself and the second insulating portion 32. The resin portion 254 is formed as a contact portion that comes into contact with the end face 22A of the tooth 22. The dividing portion 240 is formed in the resin portion 254.

More specifically, the resin portion 254 has the overlap structure. The overlap structure is configured by the first overlapping portion 256 formed by a portion of the first insulating portion 30 and the second overlapping portion 258 formed by a portion of the second insulating portion 32. The first overlapping portion 256 extends toward the Z2-side. The second overlapping portion 258 extends toward the Z1-side. The dividing portion 240 is formed passing between the first overlapping portion 256 and the second overlapping portion 258.

The first overlapping portion 256 is located inside the second overlapping portion 258 in a width direction (i.e., the X-direction) of the tooth 22, and is in contact with the end face 22A of the tooth 22. The second overlapping portion 258 is located outside the first overlapping portion 256 in the width direction (i.e., the X-direction) of the tooth 22, and is in contact with the wire-wound portion 18.

The first insulating portion 30 has the first dividing surface 264 defining the dividing portion 240. The second insulating portion 32 has the second dividing surface 266 defining the dividing portion 240. A boundary between the first dividing surface 264 and the second dividing surface 266 is defined by the dividing portion 240. The first dividing surface 264 includes the axial dividing surface 264A extending in the Z-direction and the tangential dividing surface 264B extending in the X-direction. The second dividing surface 266 includes the axial dividing surface 266A extending in the Z-direction and the tangential dividing surface 266B extending in the X-direction.

The axial dividing surface 264A and the axial dividing surface 266A divide the first insulating portion 30 and the second insulating portion 32 in the X-direction. The tangential dividing surface 264B and the tangential dividing surface 266B divide the first insulating portion 30 and the second insulating portion 32 in the Z-direction. The axial dividing surface 264A and the axial dividing surface 266A may be in contact with each other, or may be separated from each other with a gap. Similarly, the tangential dividing surface 264B and the tangential dividing surface 266B may be in contact with each other, or may be separated from each other with a gap.

The gas layer 250 is created between the first insulating portion 30 and the tooth 22, thereby securing a required degree of insulation with respect to the wire-wound portion 18 without increasing the thickness of the first insulating portion 30, as compared with a case where the gas layer 250 is not provided. This makes it possible to secure insulation with respect to the wire-wound portion 18 without increasing the physical size of the stator 10 in the Z-direction, as compared with a case where the thickness of the first insulating portion 30 is increased.

Further, the resin portion 254 is formed at the connection between the first insulating portion 30 and the second insulating portion 32. The resin portion 254 has the overlap structure in which the first overlapping portion 256 formed by a portion of the first insulating portion 30 and the second overlapping portion 258 formed by a portion of the second insulating portion 32 overlap each other. The dividing portion 240 passes between the first overlapping portion 256 and the second overlapping portion 258. This results in an increase in the creepage distance L defined by a portion of the dividing portion 240 by an amount corresponding to the dividing portion 240 passing between the first overlapping portion 256 and the second overlapping portion 258, thereby increasing the insulation at the dividing portion 240. This makes it possible to secure insulation with respect to the wire-wound portion 18 without increasing the physical size of the stator 10 in the Z-direction, as compared with a case of not having the overlap structure.

Further, the resin portion 254 is in physical contact with the end face 22A of the tooth 22. This prevents the first insulating portion 30 from being bent toward the tooth 22 due to a tightening force generated by the wire-wound portion 18, thereby suppressing a decrease in a width of the gas layer 250 in the Z-direction.

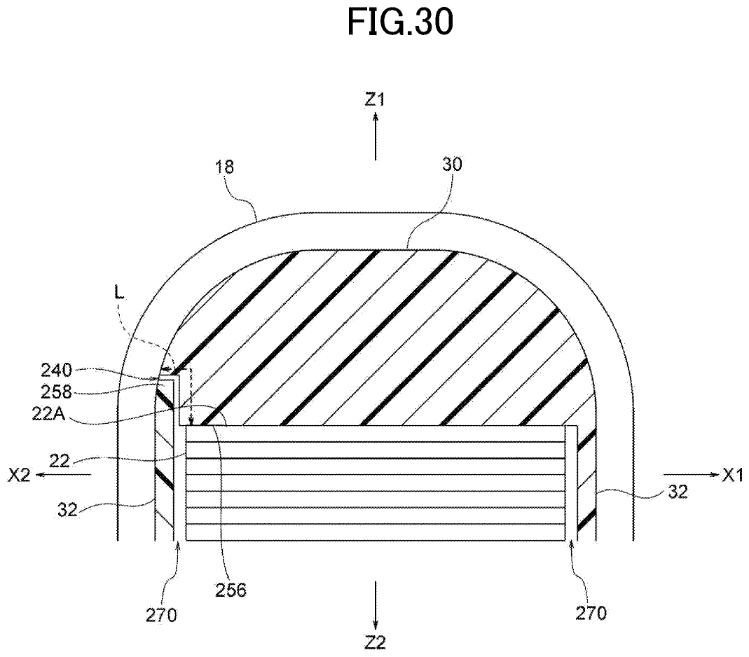

As shown in FIG. 30, the gas layer 250 provided between the first insulating portion 30 and the tooth 22 may be omitted, and the gas layers 270 may be created between the second insulating portions 32 and the tooth 22. The gas layers 270 are an example of a “third gas layer” in the technology of the present disclosure.

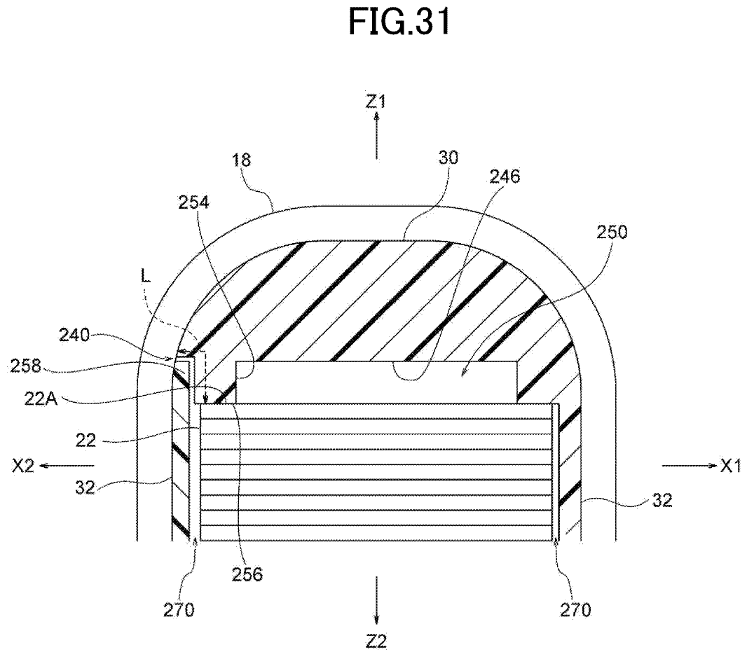

As shown in FIG. 31, the gas layer 250 may be provided between the first insulating portion 30 and the tooth 22, and the gas layers 270 may be provided between the second insulating portions 32 and the tooth 22.

### Twelfth Embodiment

Next, the twelfth embodiment of the technology of the present disclosure will be described.

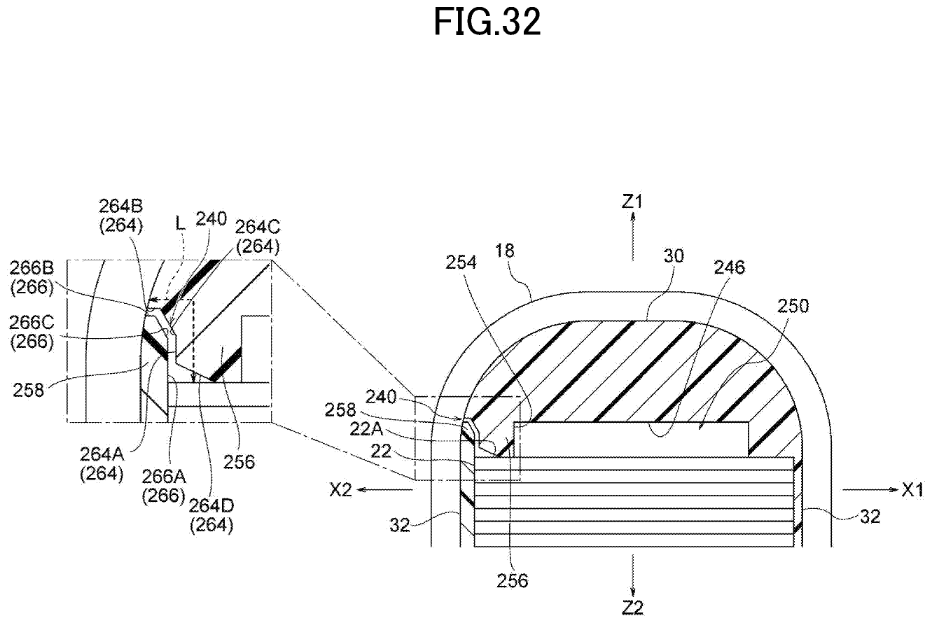

The twelfth embodiment is different from the eleventh embodiment in the configuration of the insulator 16. Specifically, as shown in FIG. 32, the first dividing surface 264 includes the axial dividing surface 264A extending in the Z-direction, the tangential dividing surface 264B extending in a tangential direction, the first inclined surface 264C, and the second inclined surface 264D. The first inclined surface 264C is formed to connect between the axial dividing surface 264A and the tangential dividing surface 264B. The first inclined surface 264C is inclined relative to the Z-direction. The second inclined surface 264D is formed on a corner of a tip of the first overlapping portion 256 and is inclined relative to the X-direction. Note that the first inclined surface 264C may be regarded as a surface inclined relative to the X-direction. Further, the second inclined surface 264D may be regarded as a surface inclined relative to the Z-direction.

The second dividing surface 266 includes the axial dividing surface 266A extending in the Z-direction, the tangential dividing surface 266B extending in the tangential direction, and the inclined surface 266C. The inclined surface 266C is formed to connect between the axial dividing surface 266A and the tangential dividing surface 266B and is inclined relative to the Z-direction. Note that the inclined surface 266C may alternatively be regarded as a surface inclined with respect to the X-direction.

The first inclined surface 264C and the inclined surface 266C define portions of the creepage distance L, thereby resulting in an increase in the creepage distance L by an amount corresponding to the first inclined surface 264C and the inclined surface 266C.

Note that, among the first inclined surface 264C, the second inclined surface 264D, and the inclined surface 266C, any inclined surface that does not define a portion of the creepage distance L may be omitted.

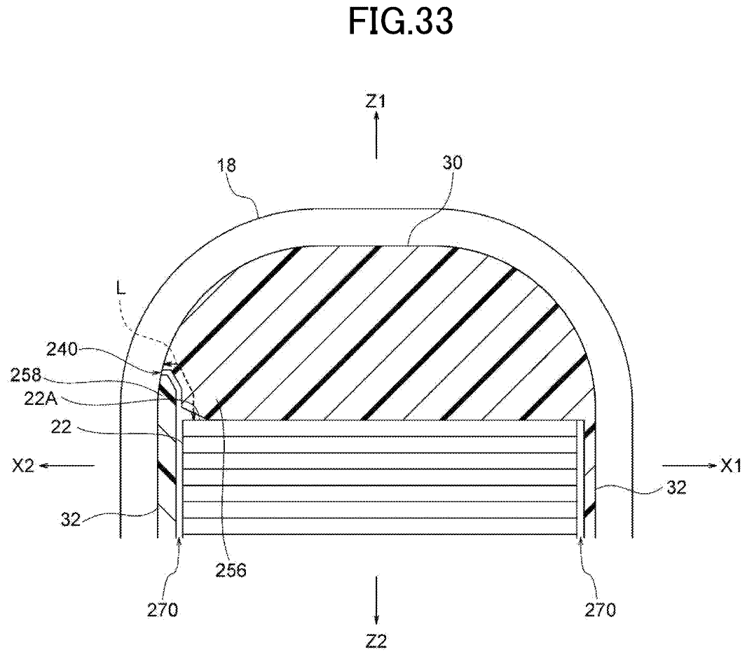

As shown in FIG. 33, the gas layers 250 provided between the first insulating portion 30 and the tooth 22 may be omitted, and the gas layers 270 may be arranged between the second insulating portions 32 and the tooth 22.

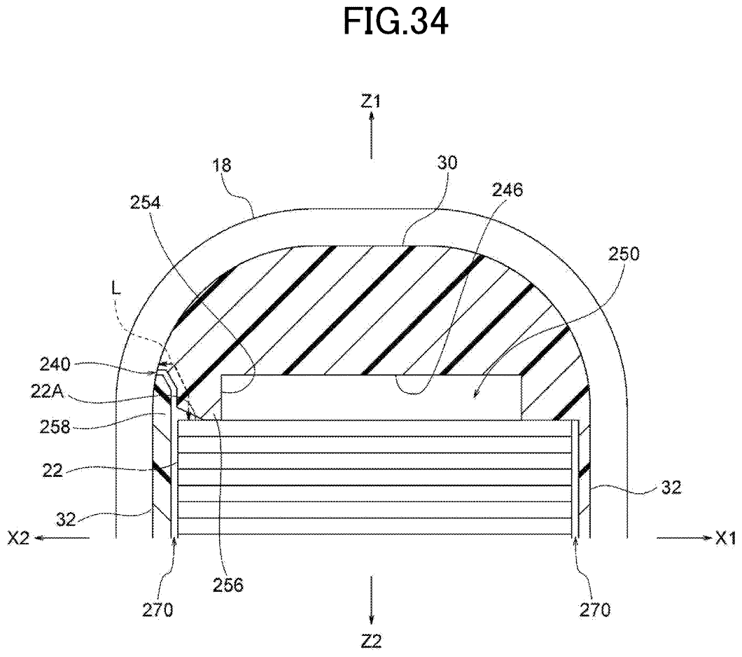

As shown in FIG. 34, the gas layer 250 may be arranged between the first insulating portion 30 and the tooth 22, and the gas layer 270 may also be arranged between the second insulating portion 32 and the tooth 22.

Further, other configurations (including modified examples) in the eleventh embodiment may be combined with the twelfth embodiment.

### Thirteenth Embodiment

Next, the thirteenth embodiment of the technology of the present disclosure will be described.

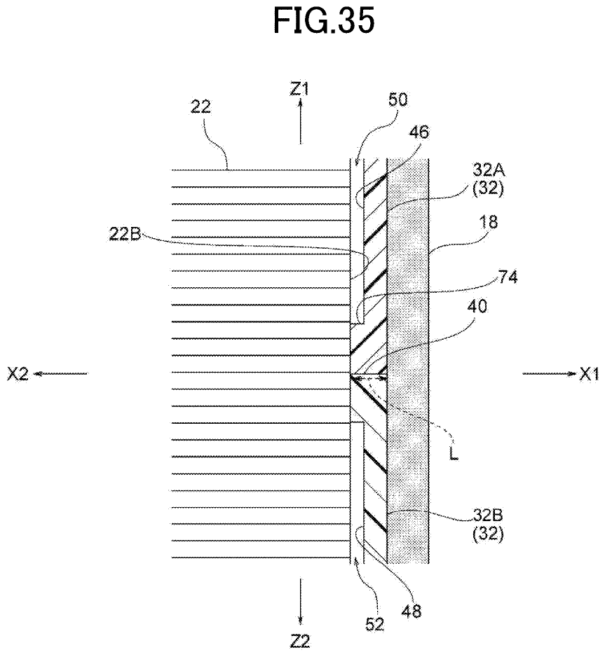

The thirteenth embodiment is different from the first embodiment in the configuration of the insulator 16. Specifically, as shown in FIG. 35, each of the second insulating portions 32 has the protrusion 74 that is formed on a central portion thereof in the Z-direction and protrudes toward the tooth 22. The protrusion 74 is an example of a “resin portion” in the technology of the present disclosure. The protrusion 74 is formed as a contact portion that comes into contact with the side surface 22B of the tooth 22. The protrusion 74 is located between the first gas layer 50 and the second gas layer 52 in the Z-direction.

The dividing portion 40 is defined between the first gas layer 50 and the second gas layer 52 in the Z-direction. Specifically, the dividing portion 40 is formed by a portion of the protrusion 74. The dividing portion 40 extends linearly in the X-direction. The upper second insulating portion 32A and the lower second insulating portion 32B are in close contact with each other in the Z-direction at the dividing portion 40. For example, the upper second insulating portion 32A and the lower second insulating portion 32B are formed with dimensions capable of being in close contact with each other in the Z-direction at the dividing portion 40 (in other words, dimensions that do not generate a gap at the dividing portion 40), and are in close contact with each other in the Z-direction at the dividing portion 40 due to a tightening force in the Z-direction by the wire-wound portion 18.

The upper second insulating portion 32A and the lower second insulating portion 32B are, as described above, in close contact with each other in the Z-direction at the dividing portion 40, thereby increasing the insulation at the dividing portion 40 as compared with a case where a gap is generated at the dividing portion 40, for example. This increases insulation with respect to the wire-wound portion 18 without decreasing the space factor of the wire-wound portion 18, as compared with a case where the thickness of the second insulating portion 32 is increased. Further, since it is unnecessary to decrease the space factor of the wire-wound portion 18, an increase in the physical size of the stator 10 can be suppressed.

Note that other configurations (including modified examples) in the first to twelfth embodiments may be combined with the thirteenth embodiment.

### Fourteenth Embodiment

Next, the fourteenth embodiment of the technology of the present disclosure will be described.

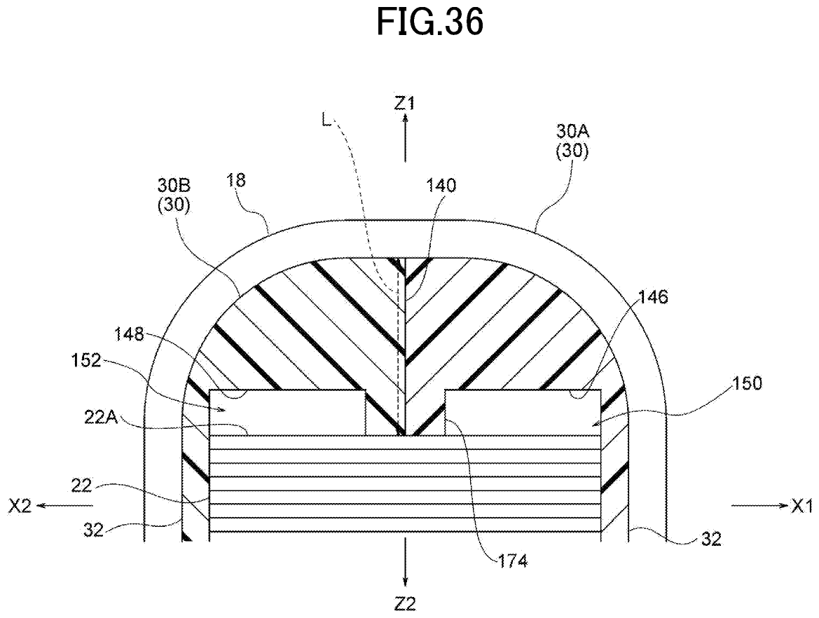

The fourteenth embodiment is different from the sixth embodiment in the configuration of the insulator 16. Specifically, as shown in FIG. 36, each of the first insulating portions 30 has the protrusion 174 formed on a central portion thereof in the X-direction. The protrusion 174 protrudes toward the tooth 22. The protrusion 174 is an example of a “resin portion” in the technology of the present disclosure. The protrusion 174 functions as a contact portion that comes into contact with the end face 22A of the tooth 22. The protrusion 174 is disposed between the first gas layer 150 and the second gas layer 152 in the X-direction.

The dividing portion 140 is formed to extend between the first gas layer 150 and the second gas layer 152 in the X-direction. Specifically, the dividing portion 140 is formed in a portion of the protrusion 174. The dividing portion 140 extends linearly in the Z-direction. The right first insulating portion 30A and the left first insulating portion 30B are in close contact with each other in the X-direction at the dividing portion 140. For example, the right first insulating portion 30A and the left first insulating portion 30B are shaped to have dimensions which achieve close contact with each other in the X-direction at the dividing portion 140 (in other words, dimensions that do not create a gap at the dividing portion 140), and are brought into close contact with each other in the X-direction at the dividing portion 140 due to a tightening force generated by the wire-wound portion 18 in the X-direction.

The right first insulating portion 30A and the left first insulating portion 30B are, as described above, in close contact with each other in the X-direction at the dividing portion 140, thereby increasing the insulation at the dividing portion 140, as compared with a case where a gap is generated at the dividing portion 140, for example. Therefore, the insulation with respect to the wire-wound portion 18 is secured without increasing a thickness of the first insulating portion 30. This makes it possible to secure insulation with respect to the wire-wound portion 18 without increasing the physical size of the stator 10 in the Z-direction, as compared with a case where the thickness of the first insulating portion 30 is increased.

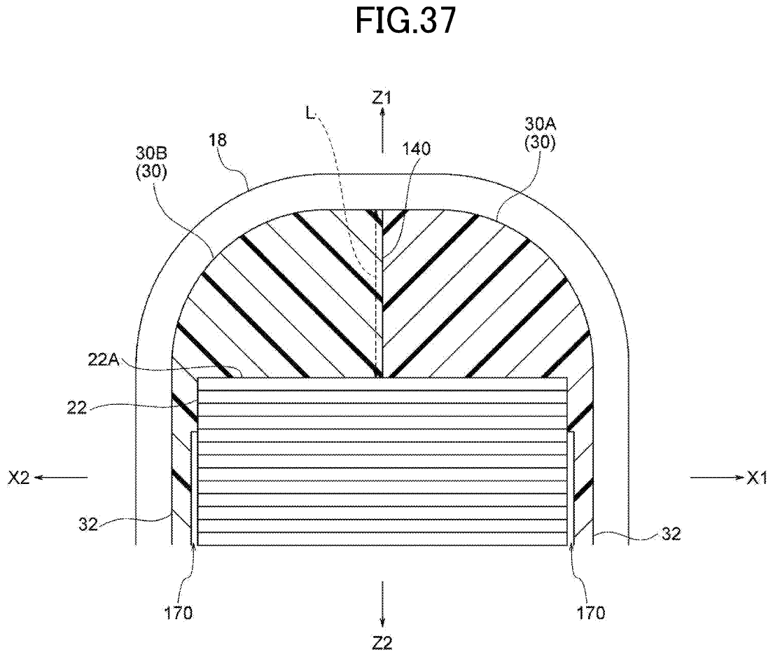

As shown in FIG. 37, the first gas layer 150 and the second gas layer 152 arranged between the first insulating portion 30 and the tooth 22 may be omitted, and the gas layers 170 may be created between the second insulating portions 32 and the tooth 22.

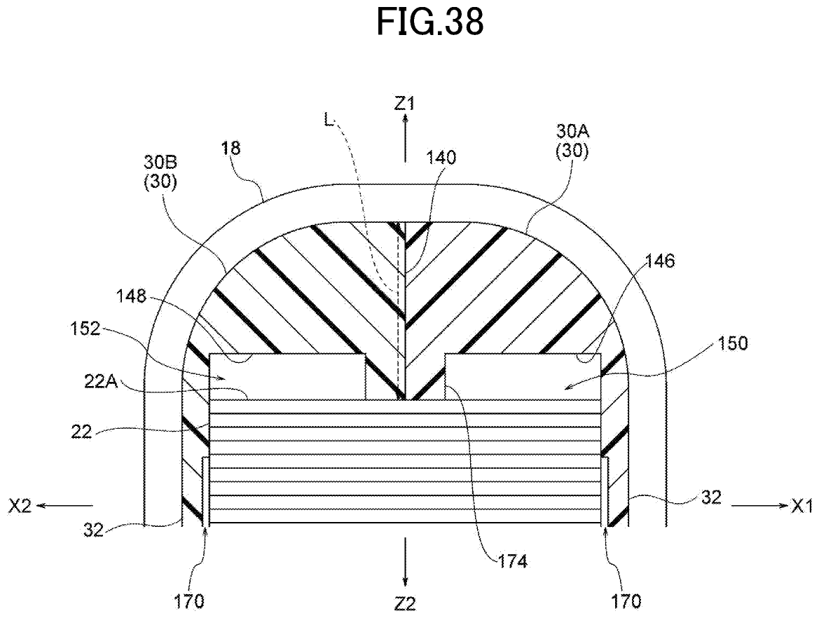

As shown in FIG. 38, the first gas layer 150 and the second gas layer 152 may be arranged between the first insulating portions 30 and the tooth 22, and the gas layers 170 may be provided between the second insulating portions 32 and the tooth 22.

Further, other configurations (including modified examples) in the first to thirteenth embodiments may be combined with the fourteenth embodiment.

### Fifteenth Embodiment

Next, the fifteenth embodiment of the technology of the present disclosure will be described.

The fifteenth embodiment is different from the eleventh embodiment in the configuration of the insulator 16. Specifically, as shown in FIG. 39, the dividing portion 240 is formed linearly in the X-direction. The first insulating portion 30 and the second insulating portion 32 are in close contact with each other in the Z-direction at the dividing portion 240. For example, the first insulating portion 30 and the second insulating portion 32 are shaped to have dimensions such that the first insulating portion 30 and the second insulating portion 32 come into close contact with each other in the Z-direction at the dividing portion 240 (in other words, dimensions that do not create a gap at the dividing portion 240). The first insulating portion 30 and the second insulating portion 32 are brought into close contact with each other in the Z-direction at the dividing portion 240 by a tightening force generated by the wire-wound portion 18 in the Z-direction.

The first insulating portion 30 and the second insulating portion 32 are in close contact with each other in the Z-direction at the dividing portion 240, thereby securing insulation at the dividing portion 240, as compared with a case where a gap is generated at the dividing portion 240. This suppresses an increase in the physical size of the stator 10, as compared with a case where thicknesses of the first insulating portion 30 and the second insulating portion 32 are increased.

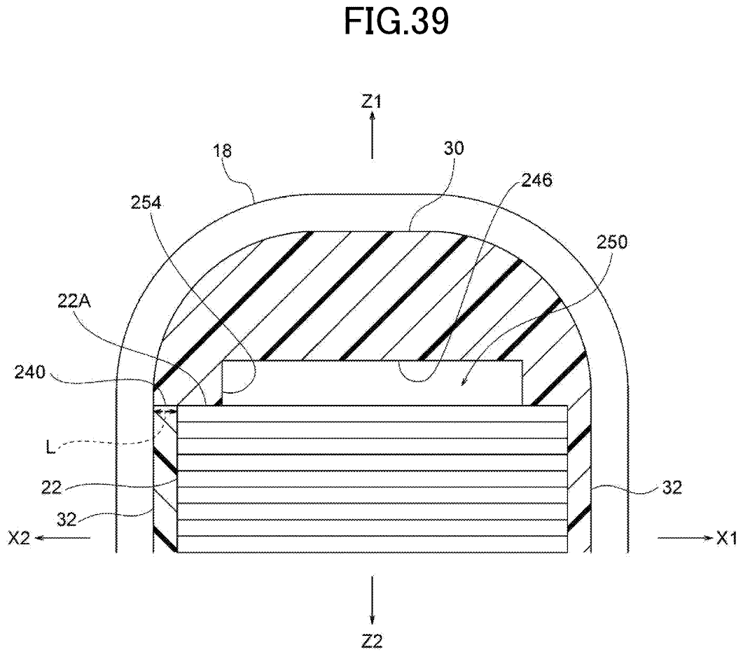

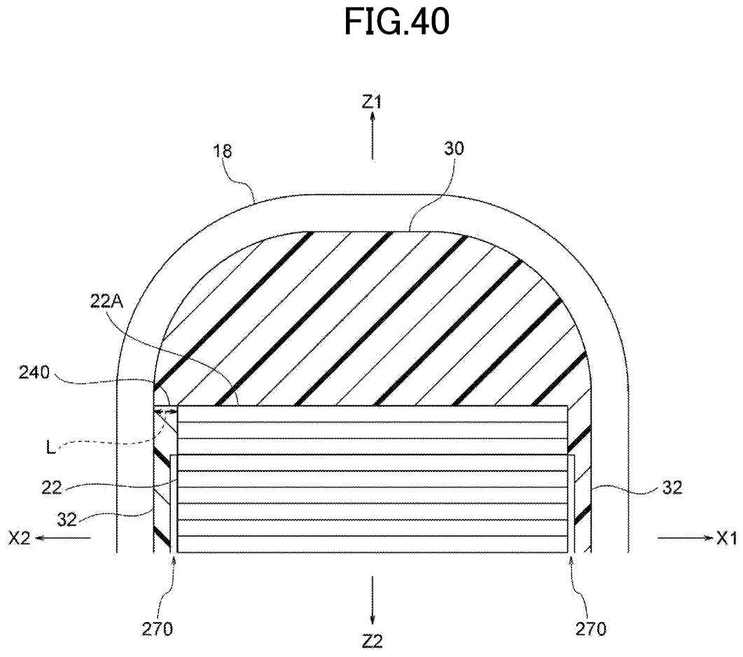

As shown in FIG. 40, the gas layer 250 arranged between the first insulating portion 30 and the tooth 22 may be omitted, and the gas layers 270 may be provided between each second insulating portion 32 and the tooth 22.

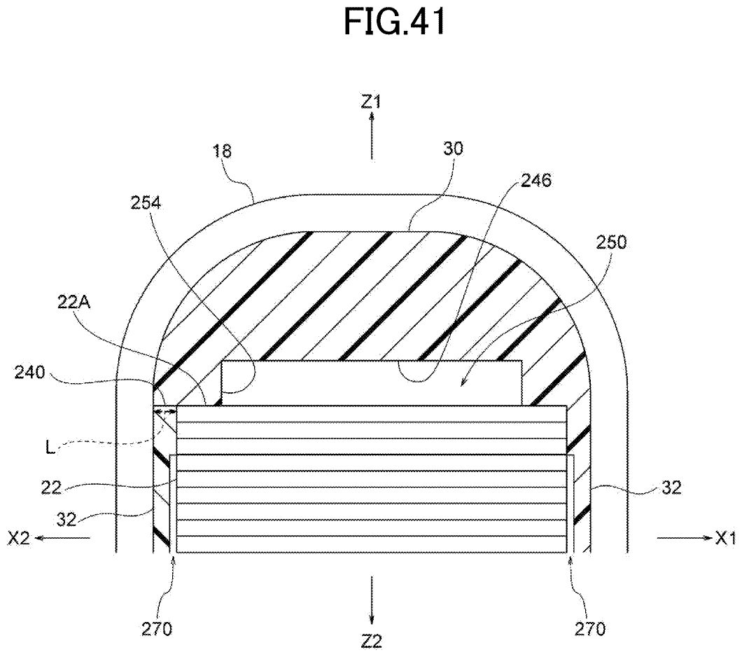

As shown in FIG. 41, the gas layer 250 may be created between the first insulating portion 30 and the tooth 22, and the gas layers 270 may be provided between the second insulating portions 32 and the tooth 22.

Further, other configurations (including modified examples) in the first to fourteenth embodiments may be combined with the fifteenth embodiment.

### Sixteenth Embodiment

Next, the sixteenth embodiment of the technology of the present disclosure will be described.

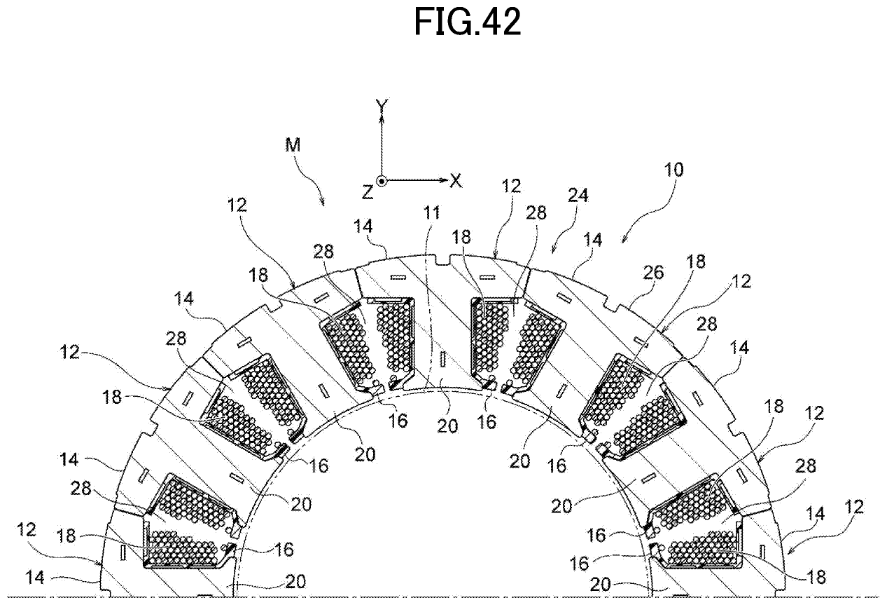

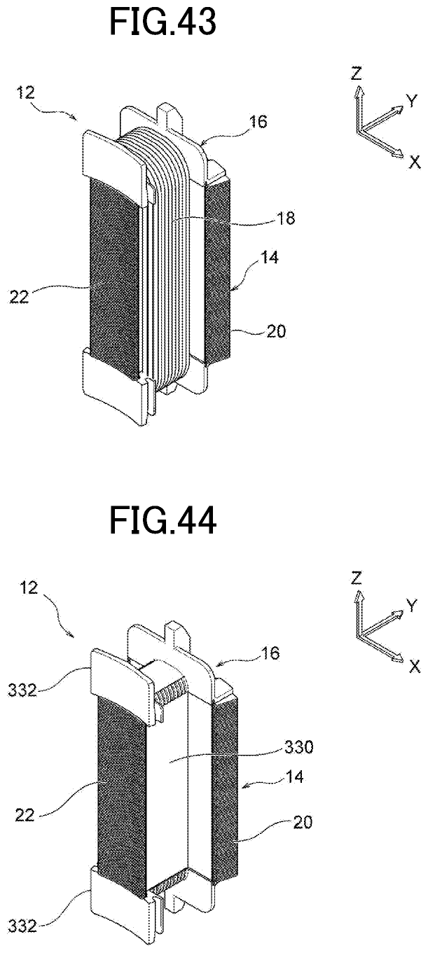

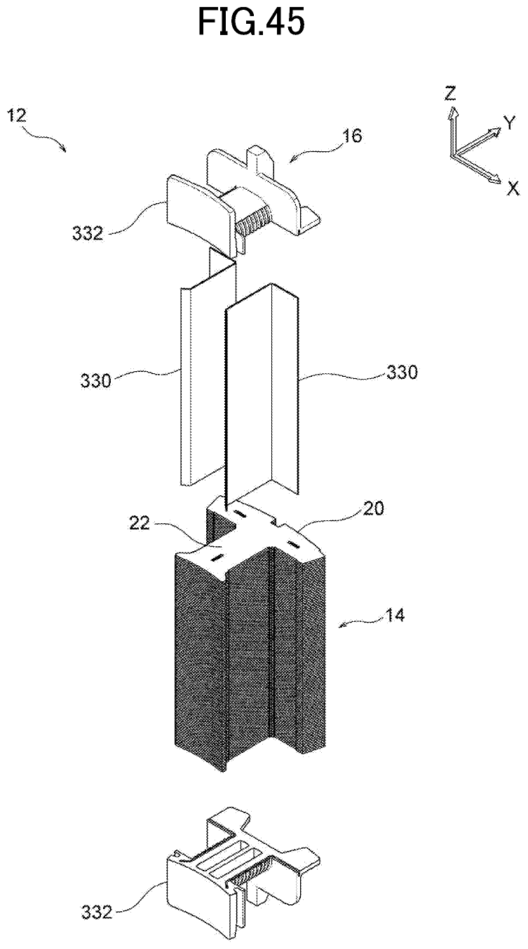

The sixteenth embodiment is different from the first embodiment in the configuration of the insulator 16. Specifically, as shown in FIGS. 42 to 45, each of the insulators 16 has a pair of first insulating members 330 and a pair of second insulating members 332. The pair of first insulating members 330 are an example of a “pair of insulating portions” and a “pair of first insulating portions” in the technology of the present disclosure, and the pair of second insulating members 332 is an example of a “pair of second insulating portions” in the technology of the present disclosure.

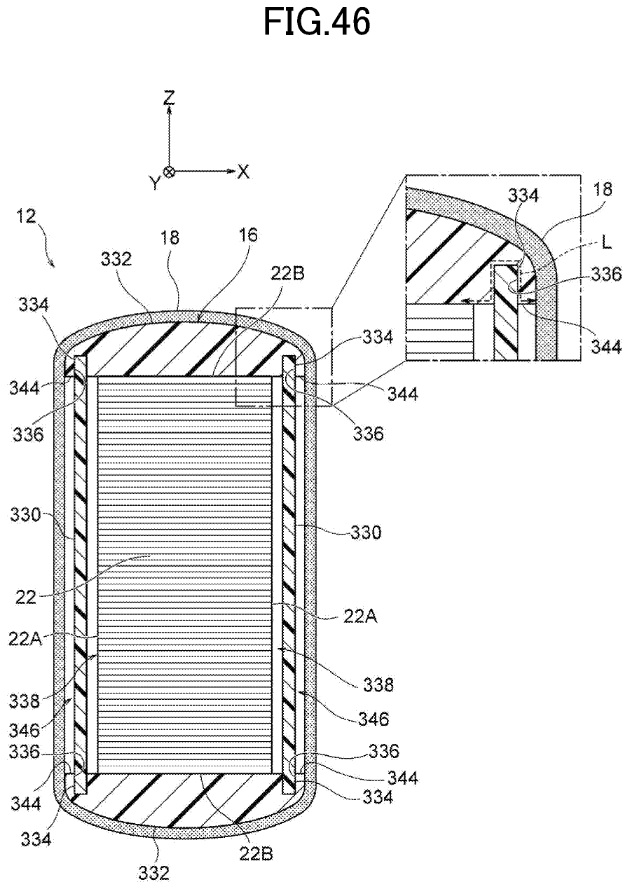

As shown in FIG. 46, the pair of first insulating members 330 respectively extend in the Z-direction. The first insulating members 330 are arranged on both sides of the tooth 22 which are opposite to each other in the X-direction, and respectively cover the side surfaces 22A of the tooth 22 opposite to each other in the X-direction. The pair of second insulating members 332 respectively extend in the X-direction. The pair of second insulating members 332 are arranged on both sides of the tooth 22 which are opposite to each other in the Z-direction and respectively cover end faces 22B of the tooth 22 in the Z-direction.

Each of the first insulating members 330 has a pair of fitting portions 334. The pair of fitting portions 334 are defined by ends of the first insulating member 330 which are opposite to each other in the Z-direction. Each of the fitting portions 334 is formed in a convex shape protruding in the Y-direction.

Each of the second insulating members 332 has a pair of fitted portions 336. The pair of fitted portions 336 are defined by ends of the second insulating member 332 which are opposite to each other in the X-direction. Each of the fitted portions 336 is formed in a concave shape recessed in the Z-direction.

The fitting portions 334 are inserted into the fitted portions 336. Securement between each of the fitting portions 334 and a corresponding one of the fitted portions 336 may be achieved by press-fitting or clearance fitting. The first insulating members 330 are attached to the second insulating members 332 by tightly fitting inserting the fitting portions 334 into the fitted portion 336. Further, the gas layers 338 are created between the tooth 22 and the first insulating members 330 in the X-direction. Positions of the fitting portions 334 and the fitted portions 336 in the X-direction are set such that the gas layers 338 are provided between the tooth 22 and the first insulating members 330 in the X-direction.

The insulator 16 is, as described above, configured to have the pair of first insulating members 330 and the pair of second insulating members 332, thereby eliminating the need for securing the creepage distance L at a dividing portion, unlike a case of a configuration in which the insulator 16 is divided into two in the Z-direction by a dividing portion set at a center portion of the tooth 22, as viewed in the Z-direction.

Further, since gas layers 338 opposite to each other in the X-direction are arranged between the tooth 22 and the first insulating members 330, insulation is secured with respect to the wire-wound portion 18 without increasing the thickness of the first insulating member 330, as compared with a case where the gas layers 338 are not provided. This increases insulation with respect to the wire-wound portion 18 without decreasing a space factor of the wire-wound portion 18, as compared with a case where the thickness of the first insulating member 330 is increased.

Further, the first insulating members 330 have the fitting portions 334, and the second insulating members 332 have the fitted portions 336 configured to receive the fitting portions 334. This increases the creepage distance L between the tooth 22 and the wire-wound portion 18 by portions corresponding to a plurality of surfaces formed on the fitting portions 334 and the fitted portions 336, thereby further improving insulation with respect to the wire-wound portion 18.

Further, the fitting portions 334 are formed in a convex shape, and the fitted portions 336 are formed in a concave shape. This eliminates the need to increase the thickness of the first insulating members 330, as compared with a case where the fitting portions 334 are formed in a concave shape and the fitted portions 336 are formed in a convex shape, thereby suppressing a reduction in the space factor of the wire-wound portion 18.

Note that each of the second insulating members 332 may have a pair of protrusions 344. The pair of protrusions 344 are formed by ends of the second insulating member 332 opposite to each other in the X-direction. The protrusions 344 protrude away from the tooth 22 in the X-direction and are in contact with the wire-wound portion 18. The gas layers 346 may be created between the second insulating members 332 and the wire-wound portion 18 by the protrusions 344 coming into contact with the wire-wound portion 18. his structure improves insulation with respect to the wire-wound portion 18 without increasing the thickness of the first insulating members 330, as compared with a case where the gas layers 346 are not provided.

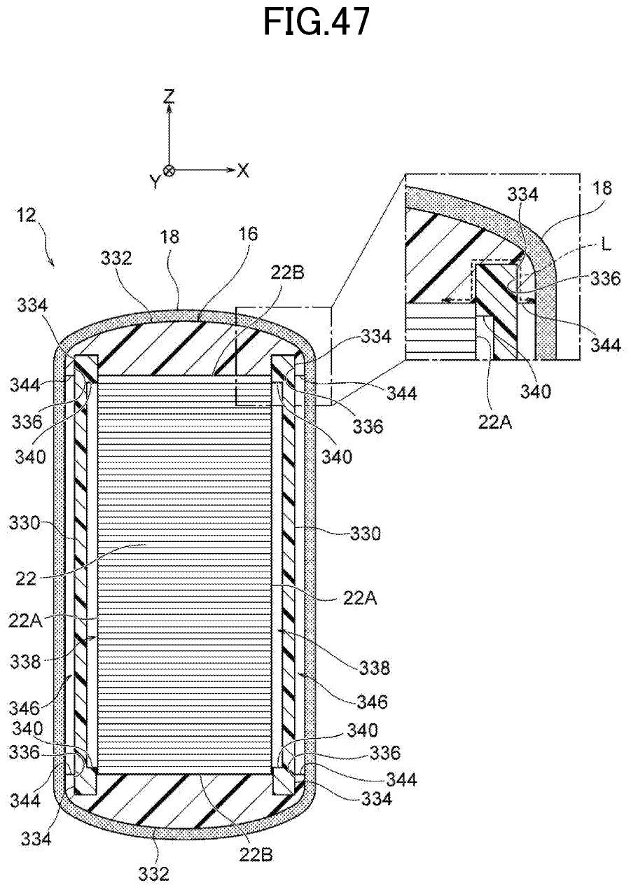

As shown in FIG. 47, each of the fitting portions 334 may have the shoulder 340 that inward protrudes in a step shape toward the tooth 22 and comes into contact with the side surface 22A of the tooth 22. The shoulders 340 are an example of a “contact portion” in the technology of the present disclosure. The shoulders 340 in contact with the side surfaces 22A of the tooth 22 serve to increase the support rigidity of the first insulating members 330 with respect to the tooth 22. This reduces bending of the first insulating members 330 when subjected to a tightening force generated by the wire-wound portion 18 and maintains the volume of the gas layers 338 substantially constant.

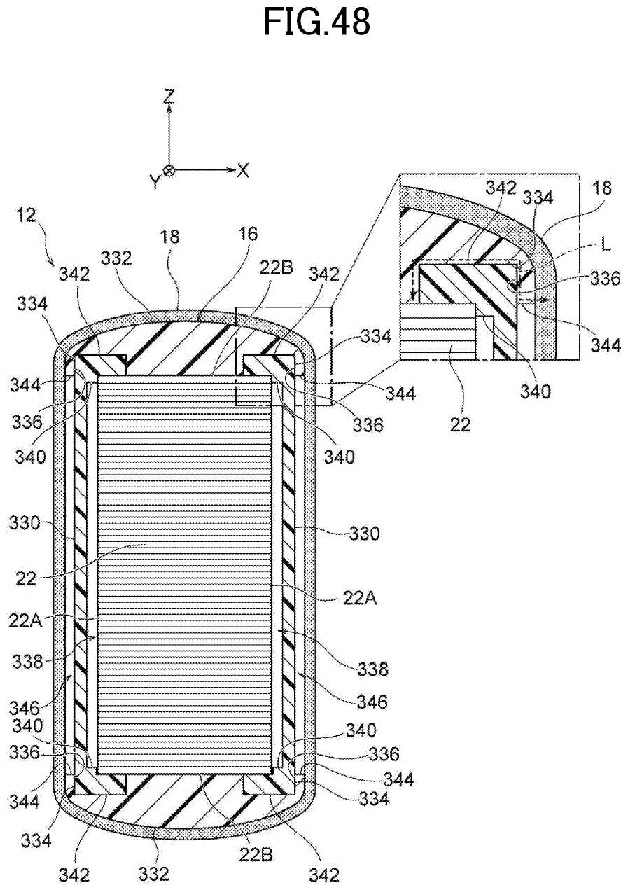

As shown in FIG. 48, each of the fitting portions 334 may have the locking portions 342 that protrude in the X-direction toward the tooth 22 and engage the tooth 22, that is, tightly hold the tooth 22 from the Z-direction. The locking portions 342 define portions of the creepage distance L between the tooth 22 and the wire-wound portion 18, thereby increasing the creepage distance L and improving insulation with respect to the wire-wound portion 18.

Further, since the locking portions 342 are tightly engaged with the tooth 22 from the Z-direction, assemblability of the first insulating members 330 to the tooth 22 is improved.

### Seventeenth Embodiment

Next, the seventeenth embodiment of the technology of the present disclosure will be described.

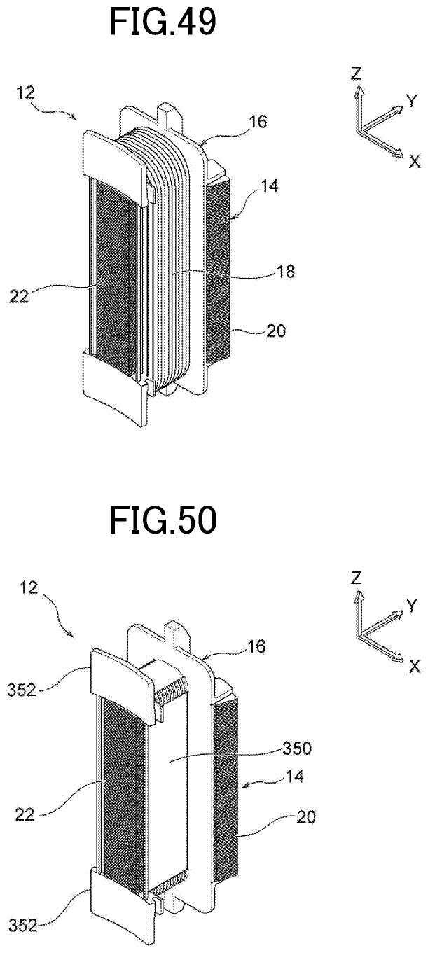

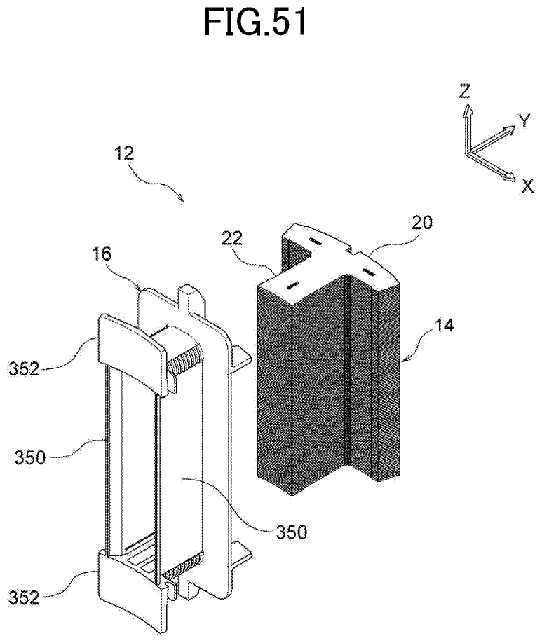

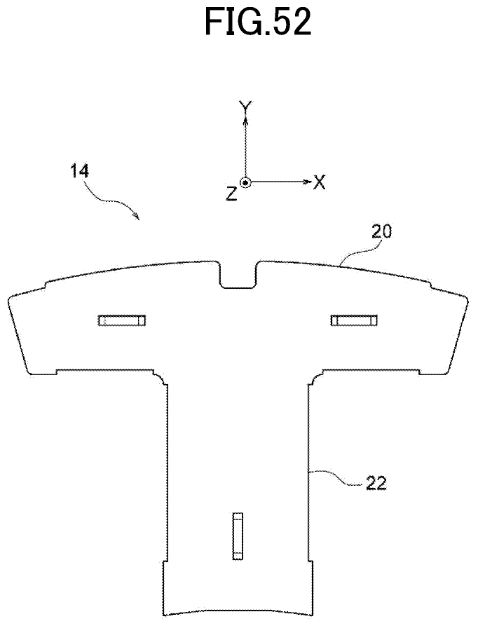

The seventeenth embodiment is different from the sixteenth embodiment in the configuration of the insulator 16. Specifically, as shown in FIGS. 49 to 51, the insulator 16 is continuously formed in an annular shape around the Y-direction so as to surround the tooth 22. As can be seen in FIG. 52, the tooth 22 is shaped to extend straight in the radial direction of the stator core 24 so that it is insertable into the annular insulator 16.

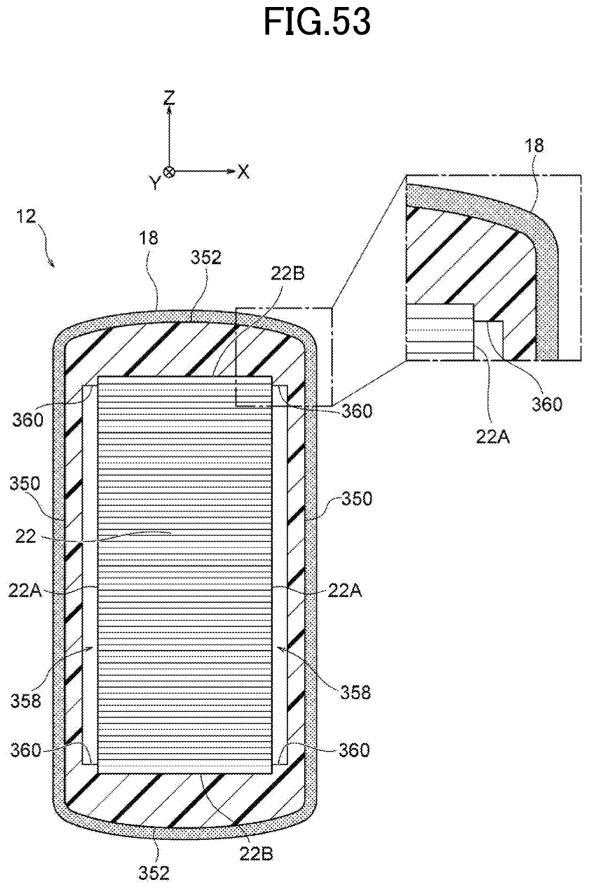

As shown in FIG. 53, the insulator 16 has a pair of first insulating portions 350 and a pair of second insulating portions 352. The pair of first insulating portions 350 is an example of a “pair of insulating portions” and a “pair of first insulating portions” in the technology of the present disclosure, and the pair of second insulating portions 352 is an example of a “pair of second insulating portions” in the technology of the present disclosure.

The first insulating portions 350 respectively extend in the Z-direction. The first insulating portions 350 are arranged on sides of the tooth 22 opposite to each other in the X-direction and respectively cover the side surfaces 22A of the tooth 22. The second insulating portions 352 respectively extend in the X-direction. The second insulating portions 352 are arranged on ends of the tooth 22 opposite to each other in the Z-direction, and respectively cover the end faces 22B of the tooth 22.

Each of the first insulating portions 350 has a pair of inner shoulders 360. The shoulders 360 are formed in a step shape on the ends of each of the first insulating portions 350 opposite to each other in the Z-direction. The shoulders 360 are in contact with the side surfaces 22A of the tooth 22, thereby defining the gas layers 358 between the tooth 22 and the first insulating portions 350. The gas layers 358 face each other in the X-direction. The shoulders 360 are an example of a “contact portion” in the technology of the present disclosure.

As described above, the insulator 16 is continuously formed in an annular shape around the Y-direction so as to surround the tooth 22, thereby eliminating the need for a dividing portion for securing the creepage distance L, unlike a configuration in which the insulator 16 is divided into two portions in the Z-direction by the dividing portion 40 provided at the center portion of the tooth 22 in the Z-direction.

Further, as compared with a case where the insulator 16 is divided into a plurality of members by dividing portions, portions of the creepage distance L along the dividing portions are eliminated. This eliminates the need to provide the insulator 16 with a structure for increasing the creepage distance L, thereby simplifying the structure of the insulator 16.

Further, since the gas layers 358 are arranged between the tooth 22 and the first insulating portions 350 in the X-direction, insulation with respect to the wire-wound portion 18 is secured without increasing the thickness of the first insulating portions 350, as compared with a case where the gas layers 358 are not provided. This improves insulation with respect to the wire-wound portion 18 without decreasing the space factor of the wire-wound portion 18, as compared with increasing the thickness of the first insulating portion 350.

Further, since the shoulders 360 are in contact with the side surfaces 22A of the tooth 22, the rigidity of the first insulating portions 350 with respect to the tooth 22 is increased. This minimizes a risk that the first insulating portions 350 may bend due to a tightening force generated by the wire-wound portion 18, and maintains the volumes of the gas layers 358 substantially constant.

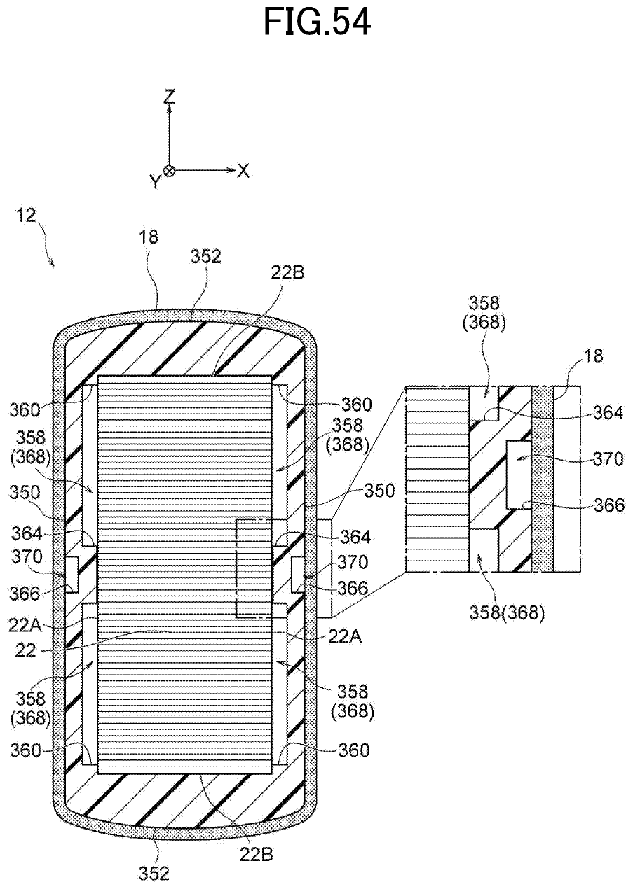

As shown in FIG. 54, each of the first insulating portions 350 may have the protrusion 364 that protrudes toward the tooth 22 and comes into contact with the side surface 22A of the tooth 22. The protrusions 364 are an example of a “contact portion” in the technology of the present disclosure. Such an arrangement further increases the rigidity of the first insulating portions 350 with respect to the tooth 22.

Further, each of the protrusions 364 is formed by a portion of a corresponding one of the first insulating portions 350 protruding toward the tooth 22. Each of the first insulating portions 350 may have the recess 366 that is formed in a portion thereof aligned with a corresponding one of the protrusions 364 and opens toward the wire-wound portion 18. Furthermore, each of the protrusions 364 defines a plurality of first gas layers 368 opposite to each other in the Z-direction. Each of the recesses 366 also defines the second gas layer 370 between the wire-wound portion 18 and a corresponding one of the first insulating portions 350. The second gas layers 370 are aligned with each other in the X-direction. The first gas layers 368 and the second gas layer 370 of each of the first insulating portion 350 may be staggered with respect to each other.

The above configuration in which the second gas layers 370 are aligned with the protrusions 364 ensures insulation with respect to the wire-wound portion 18 even if the protrusions 364 are formed on the first insulating portions 350.

### Eighteenth Embodiment

Next, the eighteenth embodiment of the technology of the present disclosure will be described.

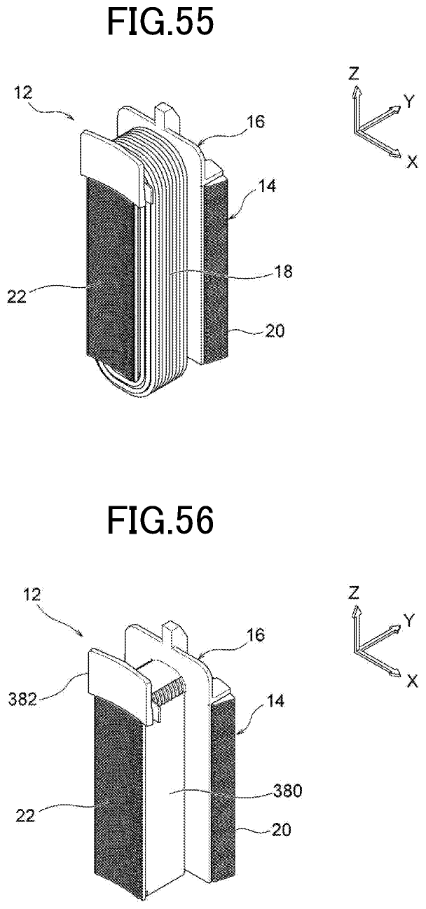

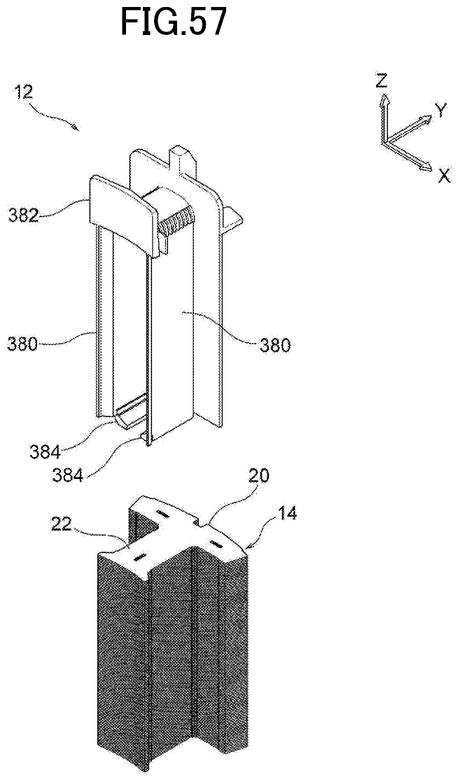

The eighteenth embodiment is different from the sixteenth embodiment in the configuration of the insulator 16. Specifically, as shown in FIGS. 55 to 57, the insulator 16 has a pair of first insulating portions 380, the second insulating portion 382, and a pair of protrusions 384. The pair of first insulating portions 380 is an example of a “pair of first insulating portions” in the technology of the present disclosure, and the second insulating portions 382 are an example of a “second insulating portion” in the technology of the present disclosure.

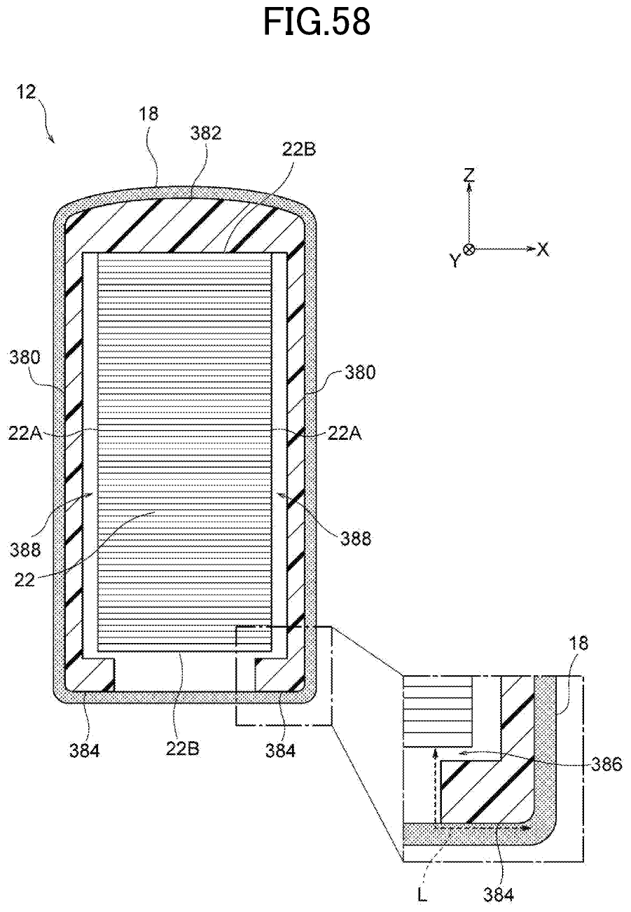

As shown in FIG. 58, the pair of first insulating portions 380 respectively extend in the Z-direction. The first insulating portions 380 are arranged on sides of the tooth 22 opposite to each other in the X-direction and respectively cover the side surfaces 22A of the tooth 22. The second insulating portion 382 extends in the X-direction. The second insulating portion 382 is arranged on one of ends of the tooth 22 opposite to each other in the Z-direction and connects ends of the first insulating portions 380 together which are opposite to each other in the Z-direction. The second insulating portion 382 covers the end face 22B of the tooth 22 which faces in the Z-direction. The gas layers 388 are created between the tooth 22 and each first insulating portions 380 in the X-direction.

The protrusions 384 protrude to face each other (that is, inward in the width direction of the tooth 22) from ends of the first insulating portions 388 which are opposite to the second insulating portion 382 in the Z-direction. The protrusions 384 are arranged on the end of the tooth 22 facing away from the second insulating portion 382 in the Z-direction. The protrusions 384 may be locked to the end face 22B of the tooth 22 or may alternatively be separated from the end face 22B in the Z-direction.

The insulator 16 is, as described above, configured to have the pair of first insulating portions 380 and the second insulating portion 382, thereby enabling the insulator 16 to be firmly attached to the tooth 22 from the one side in the Z-direction.

Further, the structure of the insulator 16 configured to have the pair of first insulating portions 380 and the second insulating portion 382 eliminates the need to secure a portion of the creepage distance L at a dividing portion, unlike a case of a configuration in which the insulator 16 is divided into two in the Z-direction by a dividing portion set at a center portion of the tooth 22 in the Z-direction.

Further, since the gas layers 388 are arranged between the tooth 22 and the first insulating portions 380 in the X-direction, insulation is secured with respect to the wire-wound portion 18 without increasing the thickness of the first insulating portion 380, as compared with a case where the gas layers 388 are not provided. This improves insulation with respect to the wire-wound portion 18 without decreasing the space factor of the wire-wound portion 18, as compared with a case where the thickness of the first insulating portion 380 is increased.

Further, the insulator 16 has the pair of protrusions 384 protruding toward each other from the ends of the first insulating portions 380 which are opposite the second insulating portion 382. The protrusions 384 are arranged on the second end of the tooth 22 which is opposite to the first end of the tooth 22 in the Z-direction. Engagement of the protrusions 384 with the end face 22B of the tooth 22 suppresses detachment of the insulator 16 from the tooth 22 in a direction away from the end face 22B in the Z-direction.

The protrusions 384 serve to increase the creepage distance L between the tooth 22 and the wire-wound portion 18, thereby further improving insulation with respect to the wire-wound portion 18.

Further, the protrusions 384 are spaced apart from the end face 22B in the Z-direction, thereby defining the gas layers 386 between the protrusions 384 and the end face 22B of the tooth 22 and further improving insulation with respect to the wire-wound portion 18.

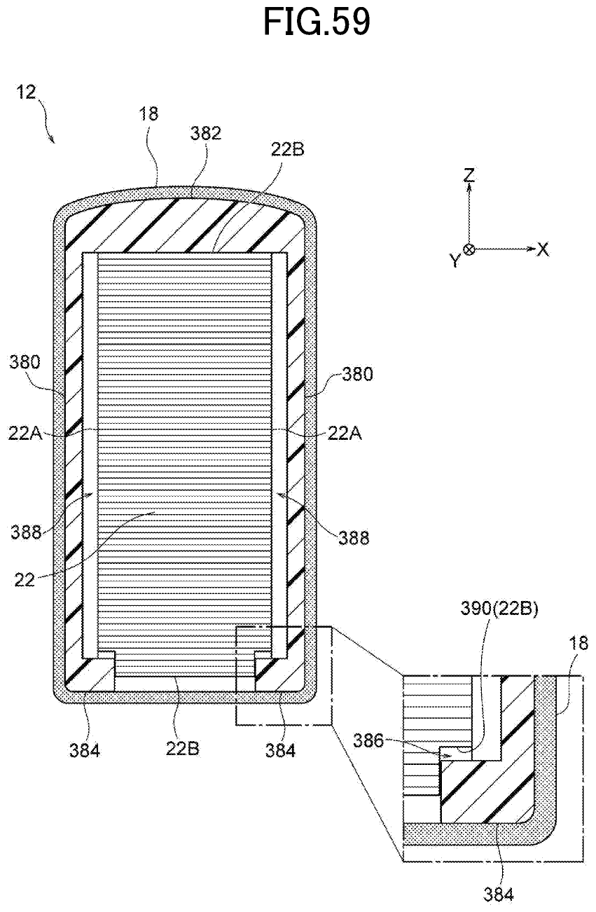

As shown in FIG. 59, the tooth 22 may have the outer steps 390 formed at corners of the end face 22B away from the second insulating portion 382. In the shown structure, the protrusions 384 are arranged on the steps 390 and are spaced apart in the Z-direction from the end face 22B (that is, from shoulder surfaces of the steps 390 facing in the Z-direction). This defines the gas layers 386 between the protrusions 384 and the end face 22B of the tooth 22 in the Z-direction, thereby increasing insulation with respect to the wire-wound portion 18.

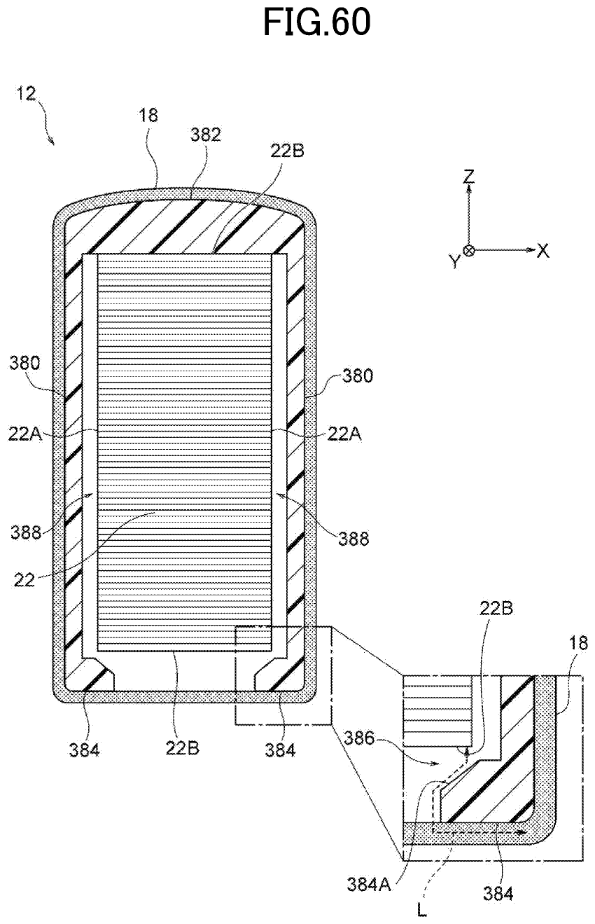

As shown in FIG. 60, each of the protrusions 384 may have the inward facing surface 384A facing the end face 22B of the tooth 22 away from the second insulating portion 383. The inward facing surfaces 384A of the protrusions 384 are defined in the form of inclined surfaces relative to the X-direction (that is, a protruding direction of the protrusions 384). Such a configuration of the protrusions 384 serves to increase the creepage distance L between the tooth 22 and the wire-wound portion 18, thereby further improving insulation property with respect to the wire-wound portion 18, as compared with a case where the inward facing surfaces 384A are shaped parallel to the X-direction.

### Nineteenth Embodiment

Next, the nineteenth embodiment of the technology of the present disclosure will be described.

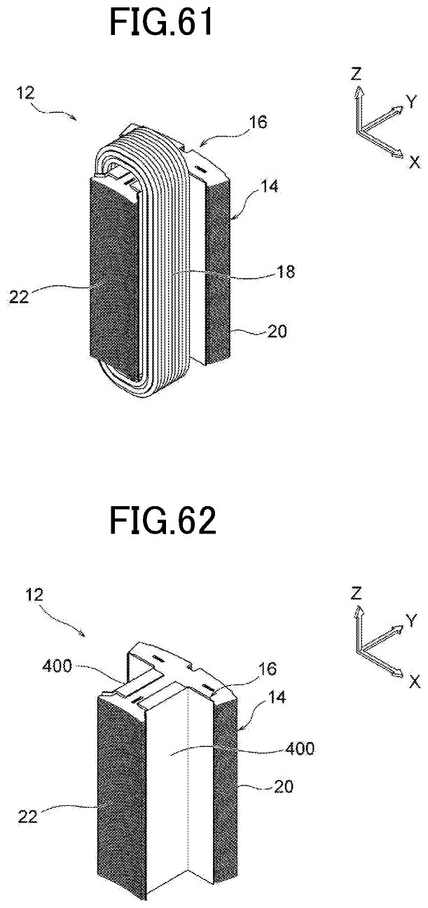

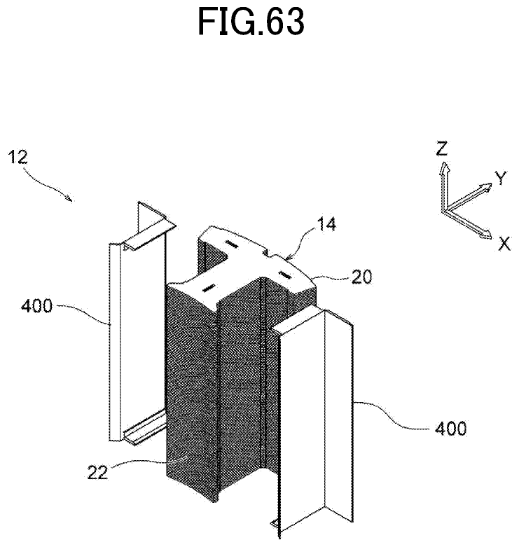

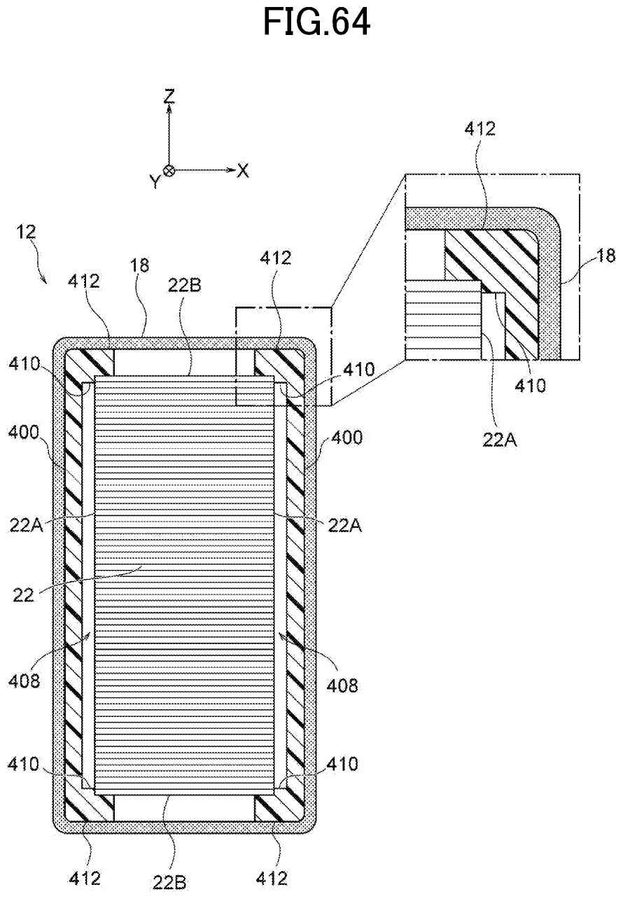

The nineteenth embodiment is different from the sixteenth embodiment in the configuration of the insulator 16. Specifically, as illustrated in FIGS. 61 to 64, the insulator 16 has a pair of insulating members 400. The pair of insulating members 400 is an example of a “pair of insulating portions” in the technology of the present disclosure.

The insulating members 400 respectively extend in the Z-direction. The insulating members 400 are arranged on sides of the tooth 22 opposite to each other in the X-direction and respectively cover the side surfaces 22A of the tooth 22 opposite to each other in the X-direction.

Each of the first insulating members 400 has a pair of step portions 410 and a pair of locking portions 412. Each of the step portions 410 is an example of a “contact portion” in the technology of the present disclosure. The step portions 410 are formed at opposite ends of each of the first insulating members 400 in the Z-direction. The step portions 410 protrude toward the tooth 22 and are in contact with the side surfaces 22A of the tooth 22. The gas layers 408 opposite to each other in the X-direction are arranged between the tooth 22 and the first insulating members 400. The gas layers 408 are defined by the step portions 410 being in contact with the side surfaces 22A of the tooth 22.

The pair of locking portions 412 are formed at ends of each of the insulating members 400 opposite to each other in the Z-direction. Each of the locking portions 412 protrudes in the X-direction toward the tooth 22 and is locked to the tooth 22 from the Z-direction.

The insulator 16 is, as described above, configured to have the pair of insulating members 400, thereby eliminating the need to secure a portion of the creepage distance L at a dividing portion, unlike a case of a configuration in which the insulator 16 is divided into two in the Z-direction by a dividing portion set at a center portion of the tooth 22 in the Z-direction.

Further, the gas layers 408 opposite to each other in the X-direction are arranged between the tooth 22 and the insulating members 400, thereby securing insulation with respect to the wire-wound portion 18 without increasing the thickness of the insulating members 400, as compared with a case where the gas layers 408 are not provided. Accordingly, a required degree of insulation with respect to the wire-wound portion 18 is secured without decreasing the space factor of the wire-wound portion 18.

Further, each of the insulating members 400 has the step portions 410 that protrude toward the tooth 22 and are in contact with the side surfaces 22A of the tooth 22, thereby increasing the support rigidity of the insulating member 400 with respect to the tooth 22. This reduces bending of the insulating member 400 when subjected to a tightening force generated by the wire-wound portion 18 and maintains the volumes of the gas layers 408 substantially constant.

Further, each of the insulating members 400 has the locking portions 412 that protrude in the X-direction and engage the tooth 22 from the Z-direction. Engagement of the locking portions 412 with the tooth 22 from the Z-direction improves assemblability of the insulating members 400 to the tooth 22.

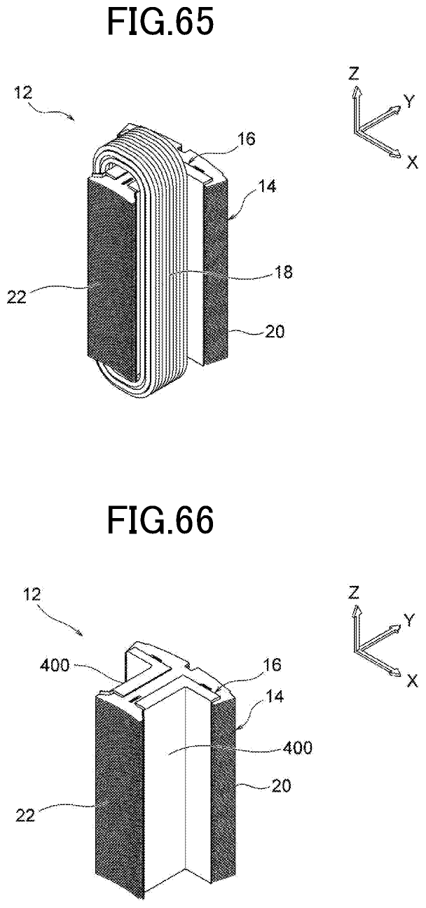

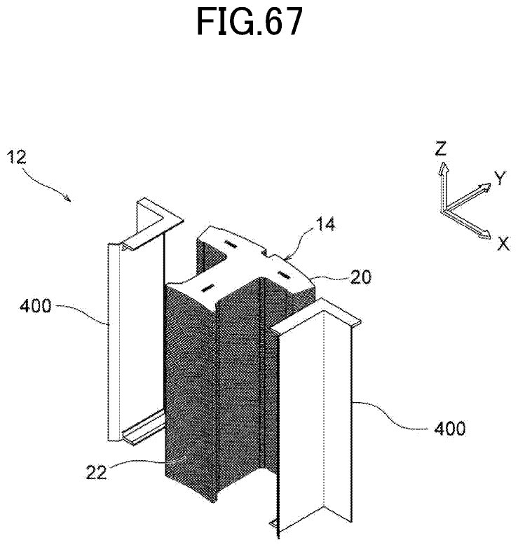

As shown in FIG. 65 to 67, each of the insulating members 400 may be shaped to a portion covering the core back 20 from the Z-direction, in addition to a portion covering the tooth 22 from the X-direction and the Z-direction.

### Twentieth Embodiment

Next, the twentieth embodiment of the technology of the present disclosure will be described.

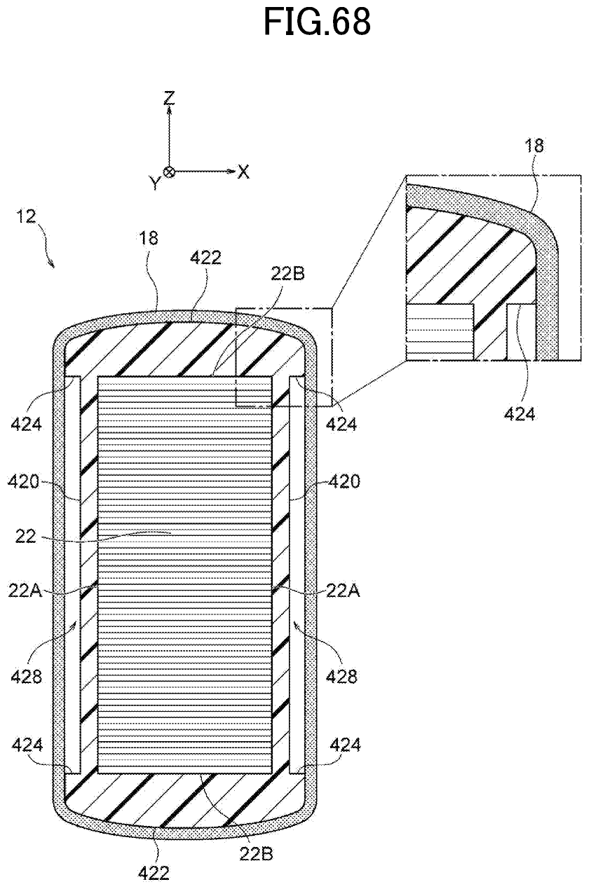

The twentieth embodiment is different from the sixteenth embodiment in the configuration of the insulator. Specifically, as shown in FIG. 68, the insulator 16 is continuously formed in an annular shape around the Y-direction and surrounds the tooth 22. For example, the insulator 16 is formed of a molded resin and is provided integrally with the tooth 22. The tooth 22 is shaped to extend straight in the radial direction of the stator core 24 so as to be insertable into the interior of the annular insulator 16.

The insulator 16 has a pair of first insulating portions 420 and a pair of second insulating portions 422. The pair of first insulating portions 420 is an example of a “pair of insulating portions” and a “pair of first insulating portions” in the technology of the present disclosure, and the pair of second insulating portions 422 is an example of a “pair of second insulating portions” in the technology of the present disclosure.

The pair of first insulating portions 420 respectively extend in the Z-direction. The first insulating portions 420 are arranged on sides of the tooth 22 opposite to each other in the X-direction and respectively cover the side surfaces 22A of the tooth 22 opposite to each other in the X-direction. The second insulating portions 422 respectively extend in the X-direction. The second insulating portions 422 are arranged on ends of the tooth 22 opposite to each other in the in the Z-direction and respectively cover the end faces 22B of the tooth 22 opposite to each other in the Z-direction.

Each of the first insulating portions 420 has a pair of protrusions 424. The protrusions 424 are formed on ends of each of the first insulating portions 420 opposite to each other in the Z-direction. Each of the protrusions 424 protrudes in the X-direction away from the tooth 22 and is in contact with the wire-wound portion 18. The protrusions 424 are in contact with the wire-wound portion 18 to define the gas layers 428 arranged between the first insulating portion 420 and the wire-wound portion 18. The gas layers 428 are an example of a “first gas layer” according to the technology of the present disclosure.

As described above, the insulator 16 is continuously formed in an annular shape around the Y-direction so as to surround the tooth 22, thereby eliminating the need for a portion of the creepage distance L associated with a dividing portion, unlike a configuration in which the insulator 16 is divided into two portions in the Z-direction by a dividing portion provided at the center portion of the tooth 22 in the Z-direction.

Further, as compared with a case where the insulator 16 is divided into a plurality of members by dividing portions, portions of the creepage distance L along the dividing portions are eliminated. This eliminates the need to provide the insulator 16 with a structure for increasing the creepage distance L, thereby simplifying the configuration of the insulator 16.

Further, the gas layers 428 opposite to each other in the X-direction are arranged between the tooth 22 and the first insulating portions 420, thereby ensuring insulation with respect to the wire-wound portion 18 without increasing the thickness of the first insulating portion 420, as compared with a case where the gas layers 428 are not provided. Accordingly, a required degree of insulation with respect to the wire-wound portion 18 is secured without decreasing the space factor of the wire-wound portion 18.

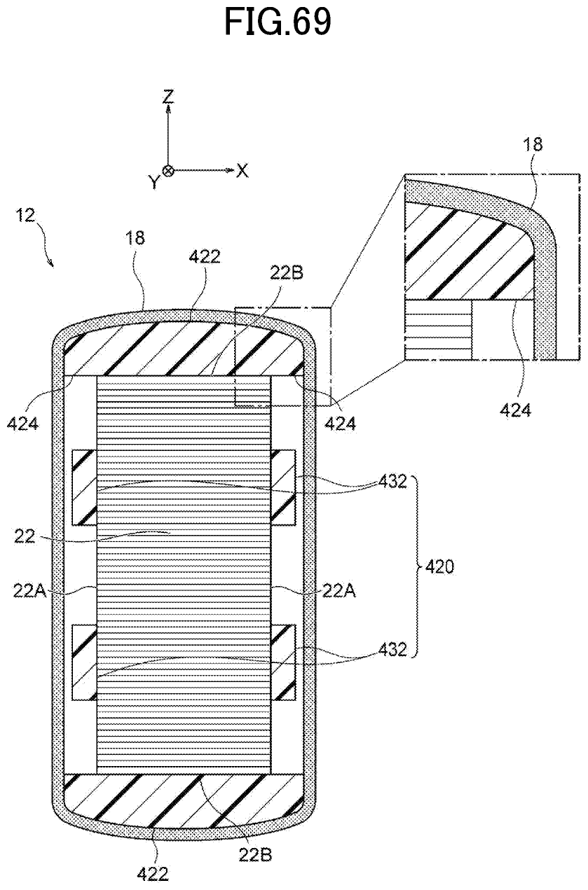

As shown in FIG. 69, the insulator 16 may be configured by a pair of first insulating portions 420 and a pair of second insulating portions 422 provided around portions of the tooth 22. Further, each second insulating portion 422 may be constituted by one or more insulating portions 432.

Further, configurations described in the first to twentieth embodiments may be combined with one another as appropriate, provided that such configurations are compatible.

Although embodiments of the technology of the present disclosure have been described above, the technology of the present disclosure is not limited thereto, and various modifications may be made without departing from the scope and spirit of the present disclosure.

This Disclosure Provides the Following Aspects.

### First Aspect

A stator (10) comprising: (a) a stator core (24) having teeth (22) extending in a radial direction of the stator core; (b) a plurality of insulators (16) that are installed on the teeth; (c) a plurality of wire-wound portions (18) that are formed by wires wound around the teeth through the insulators; (d) a pair of insulating portions (32, 330, 350, 380, 400) that extend in an axial direction of the stator core and are disposed on opposite sides of each of the teeth in a tangential direction of the stator core; and (e) gas layers (50, 52, 170, 270, 338, 358, 388, 408), each of which is located together with a respective one of the insulators between a corresponding one of the teeth and a corresponding one of the wire-wound portions in the tangential direction.

### Second Aspect

The stator as set forth in the above-described first aspect, wherein each of the insulators includes a first insulator (42, 142, 242) and a second insulator (44, 144, 244) which are discrete from each other at a dividing portion (40, 140, 240). The first insulator and the second insulator have an overlapping structure in which the first insulator includes a first overlapping portion (56, 156, 256), and the second insulator includes a second overlapping portion (58, 158, 258) overlapping the first overlapping portion. The dividing portion is formed passing between the first overlapping portion and the second overlapping portion.

### Third Aspect

A stator (10) comprising: (a) a stator core (24) having teeth (22) extending in a radial direction of the stator core; (b) a plurality of insulators (16) that are installed on the teeth; and (c) a plurality of wire-wound portions (18) that are formed by wires wound around the teeth through the insulators. Each of the insulators includes a first insulator (42, 142, 242) and a second insulator (44, 144, 244) which are discrete from each other at a dividing portion (40, 140, 240). The first insulator and the second insulator have an overlapping structure in which the first insulator includes a first overlapping portion (56, 156, 256), and the second insulator includes a second overlapping portion (58, 158, 258) overlapping the first overlapping portion. The dividing portion is formed passing between the first overlapping portion and the second overlapping portion.

### Fourth Aspect

The stator as set forth in the above-described second or third aspect, wherein a third gas layer (50, 52, 150, 152, 170, 250, 270) is disposed between each of the insulators and a corresponding one of the teeth. The third gas layer includes a first gas layer (50, 150) provided between the first insulator and the tooth and a second gas layer (52, 152) provided between the second insulator and the tooth. The dividing portion is formed in a resin portion (54, 154) between the first gas layer and the second gas layer of each of the insulators.

### Fifth Aspect

The stator as set forth in the above-described fourth aspect, wherein the dividing portion communicates with the third gas layer.

### Sixth Aspect

The stator as set forth in any one of the above-described second to fifth aspects, wherein each of the first insulators has a first dividing surface (64, 164, 264) defining a portion of the dividing portion. Each of the second insulators has a second dividing surface (66, 166, 266) defining a portion of the dividing portion. At least one of the first dividing surface and the second dividing surface includes an inclined surface (64C, 66C, 164D, 166D, 164E, 166E) inclined relative to the axial direction of the stator core or the tangential direction of the stator core.

### Seventh Aspect

The stator as set forth in any one of the above-described second to sixth aspects, wherein each of the insulator includes the first insulator and the second insulator which are discrete from each other in the axial direction of the stator core at the dividing portion. The first insulator includes a first insulating portion (30) disposed on a first side of the tooth in the axial direction of the stator core and a pair of second insulating portions (32A) disposed on opposite sides of the tooth in the tangential direction of the stator core. The second insulator includes a third insulating portion (30) disposed on a second side of the tooth opposite to the first side in the axial direction of the stator core and a pair of fourth insulating portions (32B) disposed on the opposite sides of the tooth in the tangential direction of the stator core. Before being mounted on the tooth, the pair of second insulating portions are tapered such that an interval therebetween increases toward the second side in the axial direction of the stator core. Before being mounted on the tooth, the pair of fourth insulating portions are tapered such that an interval therebetween increases toward the first side in the axial direction of the stator core. After being mounted on the tooth, the pair of second insulating portions and the pair of fourth insulating portions are pressed toward the tooth by a corresponding one of the wire-wound portions.

### Eighth Aspect

The stator as set forth in any one of the above-described second to sixth aspects, wherein the insulator includes the first insulator and the second insulator which are discrete from each other in the tangential direction of the stator core at the dividing portion. The first insulator includes a first insulating portion (32) disposed on a third side of the tooth in the tangential direction of the stator core and a pair of second insulating portions (30A) disposed on opposite sides of the tooth in the axial direction of the stator core. The second insulator includes a third insulating portion (32) disposed on a fourth side of the tooth opposite to the third side in the tangential direction of the stator core and a pair of fourth insulating portions (30B) disposed on the opposite sides of the tooth in the axial direction of the stator core. Before being mounted on the tooth, the pair of second insulating portions are tapered such that an interval therebetween increases toward the second side in the tangential direction of the stator core. Before being mounted on the tooth, the pair of fourth insulating portions are tapered such that an interval therebetween increases toward the third side in the tangential direction of the stator core. After being mounted on the tooth, the pair of second insulating portions and the pair of fourth insulating portions are pressed toward the tooth by a corresponding one of the wire-wound portions.

### Ninth Aspect

The stator as set forth in any one of the above-described second to sixth aspects, wherein each of the insulators includes the first insulator and the second insulator which are discrete from each other in the axial direction of the stator core at the dividing portion. The first overlapping portion (56) extends toward the second side in the axial direction of the stator core. The second overlapping portion (58) extends toward the first side in the axial direction of the stator core. A tip (56A) of the first overlapping portion or a tip (58A) of the second overlapping portion is inclined relative to the radial direction of the stator core when viewed from the tangential direction of the stator core.

### Tenth Aspect

The stator as set forth in any one of the above-described second to sixth aspects, wherein each of the insulators includes the first insulator and the second insulator which are discrete from each other in the tangential direction of the stator core at the dividing portion. The first overlapping portion (156) extends toward the fourth side in the tangential direction of the stator core. The second overlapping portion (158) extends toward the third side in the tangential direction of the stator core. A tip (156A) of the first overlapping portion or a tip (158A) of the second overlapping portion is inclined relative to the radial direction of the stator core when viewed from an axial direction of the stator core.

### Eleventh Aspect

The stator as set forth in the above-described fourth aspect, wherein each of the insulators has a pair of first insulating portions (30) disposed on the first and second sides of the tooth in the axial direction of the stator core, and a pair of second insulating portions (32) disposed on the third and fourth sides of the tooth in the tangential direction of the stator core. The dividing portion is provided between the first insulating portion and the second insulating portion. The third gas layer includes at least one of a gas layer (250) provided between the first insulating portion and the tooth in the axial direction of the stator core and a gas layer (270) provided between the second insulating portion and the tooth in the tangential direction of the stator core.

### Twelfth Aspect

The stator as set forth in the above-described first aspect, wherein the insulator includes a first insulator (42, 142, 242) and a second insulator (44, 144, 244) which are discrete from each other at a dividing portion. The first insulator and the second insulator are in close contact with each other at the dividing portion.

### Thirteenth Aspect

A stator comprising: (a) a stator core (24) having a plurality of teeth (22) extending in a radial direction of the stator core; (b) a plurality of insulators (16) mounted on the teeth; and (c) a plurality of wire-wound portions (18) wound around the teeth through the insulators. Each of the insulators includes a first insulator (42, 142, 242) and a second insulator (44, 144, 244) which are discrete from each other at a dividing portion. The first insulator and the second insulator are in close contact with each other at the dividing portion.

### Fourteenth Aspect

The stator as set forth in the above-described twelfth or thirteenth aspect, wherein a first gas layer (50, 150) is provided between the first insulator and the tooth. A second gas layer (52, 152) is provided between the second insulator and the tooth. The dividing portion is formed in a resin portion (54, 154) between the first gas layer and the second gas layer of each of the insulators.

### Fifteenth Aspect

The stator as set forth in the above-described first aspect, wherein each of the gas layers (338, 358, 388, 408) is arranged between a corresponding one of the teeth and one of the insulating portions in the tangential direction of the stator core.

### Sixteenth Aspect

A stator comprising: (a) a stator core (24) having a plurality of teeth (22) extending in a radial direction of the stator core; (b) a plurality of insulators (16) mounted on the teeth; and (c) a plurality of wire-wound portions (18) wound around the teeth through the insulators. Each of the insulators includes a pair of insulating portions (330, 350, 380, 400) extending in an axial direction of the stator core and disposed on opposite sides of a corresponding one of the teeth in a tangential direction of the stator core. A gas layer (338, 358, 388, 408) is provided between a corresponding one of the teeth and one of the insulating portions in the tangential direction of the stator core.

### Seventeenth Aspect

The stator as set forth in the above-described fifteenth or sixteenth aspect, wherein each of the insulators includes a pair of first insulating portions (330) as the pair of insulating portions and a pair of second insulating portions (332) extending in the tangential direction of the stator core and disposed on the first and second sides of the tooth in the axial direction of the stator core. Each of the first insulating portions has a fitting portion (334). Each of the second insulating portions has a fitted portion (336) with which the fitting portion engages.

### Eighteenth Aspect

The stator as set forth in the above-described seventeenth aspect, wherein the fitting portion is formed in a convex shape, and the fitted portion is formed in a concave shape.

### Nineteenth Aspect

The stator as set forth in the above-described seventeenth or eighteenth aspect, wherein the fitting portion has a contact portion (340) in contact with a corresponding one of the teeth.

### Twentieth Aspect

The stator as set forth in any one of the above-described seventeenth to nineteenth aspects, wherein the fitting portion includes a locking portion (342) protruding in the tangential direction of the stator core and engaging the tooth from the axial direction of the stator core.

### Twenty-First Aspect

The stator as set forth in the above-described fifteenth or sixteenth aspect, wherein each of the insulators is continuously formed in an annular shape around the radial direction of the stator core so as to surround a corresponding one of the teeth. Each of the insulators includes a pair of first insulating portions (350) as the pair of insulating portions and a pair of second insulating portions (352) extending in the tangential direction of the stator core and disposed on opposite sides of the tooth in the axial direction of the stator core.

### Twenty-Second Aspect

The stator as set forth in the above-described twenty-first aspect, wherein each of the first insulating portions has a contact portion (360, 364) in contact with the tooth.

### Twenty-Third Aspect

The stator as set forth in twenty-second aspect, wherein the contact portion includes a stepped portion (360) formed on an end of the first insulating portion in the axial direction of the stator core.

### Twenty-Fourth Aspect

The stator as set forth in the above-described twenty-second or twenty-third aspect, wherein the contact portion includes a protruding portion (364) formed on a center portion of the insulating portion in the axial direction of the stator core.

### Twenty-Fifth Aspect

The stator as set forth in the above-described twenty-fourth aspect, wherein the protruding portion is formed by a portion of a corresponding one of the first insulating portions that protrudes toward the tooth. Each of the first insulating portions has formed therein a recess (366) that opens toward a corresponding one of the wire-wound portions and is aligned with the protruding portion. The gas layer (358) includes a plurality of first gas layers (368) defined by the protruding portion and arranged in the axial direction of the stator core. A second gas layer (370) defined by the recess is arranged between a corresponding one of the wire-wound portions and a corresponding one of the first insulating portions in the tangential direction of the stator core. The plurality of first gas layers and the second gas layer are staggered.

### Twenty-Sixth Aspect

The stator as set forth in the above-described fifteenth or sixteenth aspect, wherein each of the insulators includes: a pair of first insulating portions (380) as the pair of insulating portions; a second insulating portion (382) extending in a tangential direction of the stator core, disposed on a first side of the tooth in the axial direction of the stator core, and connecting the pair of first insulating portions; and a pair of protruding portions (384) protruding to face each other from ends of the first insulating portions opposite to the second insulating portion. The protruding portions are disposed on a second side of the tooth opposite to the first side in the axial direction of the stator core.

### Twenty-Seventh Aspect

The stator as set forth in the above-described fifteenth or sixteenth aspect, wherein each of the insulating portions (400) includes contact portions (410) that are in contact with the tooth and define a gas layer (408) between the tooth and a corresponding one of the insulating portions in the tangential direction of the stator core.

### Twenty-Eighth Aspect

The stator as set forth in the above-described first aspect, wherein each of the insulators includes a pair of first insulating portions (420) extending in the axial direction of the stator core and disposed on opposite sides of the tooth in the tangential direction of the stator core. A first gas layer (428) is provided between a corresponding one of the wire-wound portions and a corresponding one of the first insulating portions in the tangential direction of the stator core.

### Twenty-Ninth Aspect

A stator (10) comprising: (a) a stator core (24) having a plurality of teeth (22) extending in a radial direction of the stator core; (b) a plurality of insulators (16) mounted on the teeth; and (c) a plurality of wire-wound portions (18) wound around the teeth through the insulators. Each of the insulators includes a pair of first insulating portions (420) extending in an axial direction of the stator core and disposed on opposite sides of a corresponding one of the teeth in a tangential direction of the stator core. First gas layers (428) are arranged between a corresponding one of the wire-wound portions and the first insulating portions of each of the insulators in the tangential direction of the stator core.

### Thirtieth Aspect

The stator as set forth in the above-described twenty-eighth or twenty-ninth aspect, wherein each of the insulators includes: a pair of the first insulating portions (420); and a pair of second insulating portions (422) extending in the tangential direction of the stator core and disposed on opposite sides of each of the teeth in the axial direction of the stator core. Each of the second insulating portions has protruding portions (424) protruding in the tangential direction of the stator core and configured to come into contact with a corresponding one of the wire-wound portions. The protruding portions of each of the second insulating portions define a corresponding one of the first gas layers between the second insulating portion and the wire-wound portion in the tangential direction of the stator core.

### Thirty-First Aspect

The stator as set forth in the above-described twenty-eighth or twenty-ninth aspect, wherein each of the insulator is continuously formed in an annular shape around the radial direction of the stator core so as to surround a corresponding one of the teeth.

### Thirty-Second Aspect

The stator as set forth in the above-described twenty-eighth or twenty-ninth aspect, wherein each of the insulators is partially provided around a corresponding one of the teeth.

### Thirty-Third Aspect

A rotating electrical machine (M) comprising: the stator according to any one of the above-described first to thirty-second aspects; and a rotor (11) rotatably disposed inside the stator.

1. A stator comprising:
a stator core having teeth extending in a radial direction of the stator core;
a plurality of insulators that are installed on the teeth;
a plurality of wire-wound portions that are formed by wires wound around the teeth through the insulators;
a pair of insulating portions that extend in an axial direction of the stator core and are disposed on opposite sides of each of the teeth in a tangential direction of the stator core; and
gas layers, each of which is disposed together with a respective one of the insulators between a corresponding one of the teeth and a corresponding one of the wire-wound portions in the tangential direction.

2. The stator according to claim 1, wherein each of the insulators includes a first insulator and a second insulator which are discrete from each other at a dividing portion,
the first insulator and the second insulator have an overlapping structure in which the first insulator includes a first overlapping portion, and the second insulator includes a second overlapping portion overlapping the first overlapping portion, and
the dividing portion is formed passing between the first overlapping portion and the second overlapping portion.

3. A stator comprising:
a stator core having teeth extending in a radial direction of the stator core;
a plurality of insulators that are installed on the teeth; and
a plurality of wire-wound portions that are formed by wires wound around the teeth through the insulators, wherein
each of the insulators includes a first insulator and a second insulator which are discrete from each other at a dividing portion,
the first insulator and the second insulator have an overlapping structure in which the first insulator includes a first overlapping portion, and the second insulator includes a second overlapping portion overlapping the first overlapping portion, and
the dividing portion is formed passing between the first overlapping portion and the second overlapping portion.

4. The stator according to claim 2, wherein a third gas layer is disposed between each of the insulators and a corresponding one of the teeth,
the third gas layer includes a first gas layer provided between the first insulator and the tooth and a second gas layer provided between the second insulator and the tooth,
the dividing portion is formed in a resin portion between the first gas layer and the second gas layer of each of the insulators.

5. The stator according to claim 4, wherein the dividing portion communicates with the third gas layer.

6. The stator according to claim 2, wherein each of the first insulators has a first dividing surface defining a portion of the dividing portion,
each of the second insulators has a second dividing surface defining a portion of the dividing portion, and
at least one of the first dividing surface and the second dividing surface includes an inclined surface inclined relative to the axial direction of the stator core or the tangential direction of the stator core.

7. The stator according to claim 2, wherein each of the insulator includes the first insulator and the second insulator which are discrete from each other in the axial direction of the stator core at the dividing portion,
the first insulator includes a first insulating portion disposed on a first side of the tooth in the axial direction of the stator core and a pair of second insulating portions disposed on opposite sides of the tooth in the tangential direction of the stator core,
the second insulator includes a third insulating portion disposed on a second side of the tooth opposite to the first side in the axial direction of the stator core and a pair of fourth insulating portions disposed on the opposite sides of the tooth in the tangential direction of the stator core,
before being mounted on the tooth, the pair of second insulating portions are tapered such that an interval therebetween increases toward the second side in the axial direction of the stator core,
before being mounted on the tooth, the pair of fourth insulating portions are tapered such that an interval therebetween increases toward the first side in the axial direction of the stator core, and
after being mounted on the tooth, the pair of second insulating portions and the pair of fourth insulating portions are pressed toward the tooth by a corresponding one of the wire-wound portions.

8. The stator according to claim 2, wherein the insulator includes the first insulator and the second insulator which are discrete from each other in the tangential direction of the stator core at the dividing portion,
the first insulator includes a first insulating portion disposed on a third side of the tooth in the tangential direction of the stator core and a pair of second insulating portions disposed on opposite sides of the tooth in the axial direction of the stator core,
the second insulator includes a third insulating portion disposed on a fourth side of the tooth opposite to the third side in the tangential direction of the stator core and a pair of fourth insulating portions disposed on the opposite sides of the tooth in the axial direction of the stator core,
before being mounted on the tooth, the pair of second insulating portions are tapered such that an interval therebetween increases toward the second side in the tangential direction of the stator core,
before being mounted on the tooth, the pair of fourth insulating portions are tapered such that an interval therebetween increases toward the third side in the tangential direction of the stator core, and
after being mounted on the tooth, the pair of second insulating portions and the pair of fourth insulating portions are pressed toward the tooth by a corresponding one of the wire-wound portions.

9. The stator according to claim 2, wherein each of the insulators includes the first insulator and the second insulator which are discrete from each other in the axial direction of the stator core at the dividing portion,
the first overlapping portion extends toward the second side in the axial direction of the stator core,
the second overlapping portion extends toward the first side in the axial direction of the stator core,
a tip of the first overlapping portion or a tip of the second overlapping portion is inclined relative to the radial direction of the stator core when viewed from the tangential direction of the stator core.

10. The stator according to claim 2, wherein each of the insulators includes the first insulator and the second insulator which are discrete from each other in the tangential direction of the stator core at the dividing portion,
the first overlapping portion extends toward the fourth side in the tangential direction of the stator core,
the second overlapping portion extends toward the third side in the tangential direction of the stator core, and
a tip of the first overlapping portion or a tip of the second overlapping portion is inclined relative to the radial direction of the stator core when viewed from an axial direction of the stator core.

11. The stator according to claim 4, wherein each of the insulators includes a pair of first insulating portions disposed on the first and second sides of the tooth in the axial direction of the stator core, and a pair of second insulating portions disposed on the third and fourth sides of the tooth in the tangential direction of the stator core,
the dividing portion is provided between the first insulating portion and the second insulating portion,
the third gas layer includes at least one of a gas layer provided between the first insulating portion and the tooth in the axial direction of the stator core and a gas layer provided between the second insulating portion and the tooth in the tangential direction of the stator core.

12. The stator according to claim 1, wherein the insulator includes a first insulator and a second insulator which are discrete from each other at a dividing portion,
the first insulator and the second insulator are in close contact with each other at the dividing portion.

13. A stator comprising:
a stator core having a plurality of teeth extending in a radial direction of the stator core;
a plurality of insulators mounted on the teeth; and
a plurality of wire-wound portions wound around the teeth through the insulators, wherein
each of the insulators includes a first insulator and a second insulator which are discrete from each other at a dividing portion, and
the first insulator and the second insulator are in close contact with each other at the dividing portion.

14. The stator according to claim 12, wherein a first gas layer is provided between the first insulator and the tooth,
a second gas layer is provided between the second insulator and the tooth, and
the dividing portion is formed in a resin portion between the first gas layer and the second gas layer of each of the insulators.

15. The stator according to claim 1, wherein each of the gas layers is arranged between a corresponding one of the teeth and one of the insulating portions in the tangential direction of the stator core.

16. A stator comprising:
a stator core having a plurality of teeth extending in a radial direction of the stator core;
a plurality of insulators mounted on the teeth; and
a plurality of wire-wound portions wound around the teeth through the insulators, wherein
each of the insulators includes a pair of insulating portions extending in an axial direction of the stator core and disposed on opposite sides of a corresponding one of the teeth in a tangential direction of the stator core, and
a gas layer is provided between a corresponding one of the teeth and one of the insulating portions in the tangential direction of the stator core.

17. The stator according to claim 15, wherein each of the insulators includes a pair of first insulating portions as the pair of insulating portions and a pair of second insulating portions extending in the tangential direction of the stator core and disposed on the first and second sides of the tooth in the axial direction of the stator core,
each of the first insulating portions has a fitting portion, and
each of the second insulating portions has a fitted portion with which the fitting portion engages.

18. The stator according to claim 17, wherein the fitting portion is formed in a convex shape, and wherein the fitted portion is formed in a concave shape.

19. The stator according to claim 17, wherein the fitting portion has a contact portion in contact with a corresponding one of the teeth.

20. The stator according to claim 17, wherein the fitting portion includes a locking portion protruding in the tangential direction of the stator core and engaging the tooth from the axial direction of the stator core.

21. The stator according to claim 15, wherein each of the insulators is continuously formed in an annular shape around the radial direction of the stator core so as to surround a corresponding one of the teeth, and
each of the insulators includes a pair of first insulating portions as the pair of insulating portions and a pair of second insulating portions extending in the tangential direction of the stator core and disposed on opposite sides of the tooth in the axial direction of the stator core.

22. The stator according to claim 21, wherein each of the first insulating portions has a contact portion in contact with the tooth.

23. The stator according to claim 22, wherein the contact portion includes a stepped portion formed on an end of the first insulating portion in the axial direction of the stator core.

24. The stator according to claim 22, wherein the contact portion includes a protruding portion formed on a center portion of the insulating portion in the axial direction of the stator core.

25. The stator according to claim 24, wherein the protruding portion is formed by a portion of a corresponding one of the first insulating portions that protrudes toward the tooth,
each of the first insulating portions has formed therein a recess that opens toward a corresponding one of the wire-wound portions and is aligned with the protruding portion,
the gas layer includes a plurality of first gas layers defined by the protruding portion and arranged in the axial direction of the stator core,
a second gas layer defined by the recess is arranged between a corresponding one of the wire-wound portions and a corresponding one of the first insulating portions in the tangential direction of the stator core, and
the plurality of first gas layers and the second gas layer are staggered.

26. The stator according to claim 15, wherein each of the insulators includes: a pair of first insulating portions as the pair of insulating portions; a second insulating portion extending in a tangential direction of the stator core, disposed on a first side of the tooth in the axial direction of the stator core, and connecting the pair of first insulating portions; and a pair of protruding portions protruding to face each other from ends of the first insulating portions opposite to the second insulating portion, the protruding portions being disposed on a second side of the tooth opposite to the first side in the axial direction of the stator core.

27. The stator according to claim 15, wherein each of the insulating portions includes contact portions that are in contact with the tooth and define a gas layer between the tooth and a corresponding one of the insulating portions in the tangential direction of the stator core.

28. The stator according to claim 1, wherein each of the insulators includes a pair of first insulating portions extending in the axial direction of the stator core and disposed on opposite sides of the tooth in the tangential direction of the stator core, and
a first gas layer is provided between a corresponding one of the wire-wound portions and a corresponding one of the first insulating portions in the tangential direction of the stator core.

29. A stator comprising:
a stator core having a plurality of teeth extending in a radial direction of the stator core;
a plurality of insulators mounted on the teeth; and
a plurality of wire-wound portions wound around the teeth through the insulators, wherein
each of the insulators includes a pair of first insulating portions extending in an axial direction of the stator core and disposed on opposite sides of a corresponding one of the teeth in a tangential direction of the stator core, and
first gas layers are arranged between a corresponding one of the wire-wound portions and the first insulating portions of a corresponding one of the insulators in the tangential direction of the stator core.

30. The stator according to claim 28, wherein each of the insulators includes: a pair of the first insulating portions; and a pair of second insulating portions extending in the tangential direction of the stator core and disposed on opposite sides of each of the teeth in the axial direction of the stator core, wherein
each of the second insulating portions has protruding portions protruding in the tangential direction of the stator core and configured to come into contact with a corresponding one of the wire-wound portions, and
the protruding portions of each of the second insulating portions define a corresponding one of the first gas layers between the second insulating portion and the wire-wound portion in the tangential direction of the stator core.

31. The stator according to claim 28, wherein each of the insulator is continuously formed in an annular shape around the radial direction of the stator core so as to surround a corresponding one of the teeth.

32. The stator according to claim 28, wherein each of the insulators is partially provided around a corresponding one of the teeth.

33. A rotating electrical machine comprising: the stator according to claim 1; and a rotor rotatably disposed inside the stator.
